(19) United States
(12) Patent Application Publication
(10) Pub. No.: US 2023/0361917 A1
(43) Pub. Date: Nov. 9, 2023

(54) SEMI-PERSISTENT SCHEDULING IN LATENCY-SENSITIVE SYSTEMS

(71) Applicant: GOOGLE LLC, Mountain View, CA (US)

(72) Inventor: Kao-Peng Chou, Taoyuan City (TW)

(21) Appl. No.: 18/018,825

(22) PCT Filed: Aug. 5, 2021
(86) PCT No.: PCT/US21/44724

§ 371 Date: Jan. 30, 2023

Related U.S. Application Data
(60) Provisional application No. 63/131,636, filed on Dec. 29, 2020.
(60) Provisional application No. 63/062,262, filed on Aug. 6, 2020.

(51) Int. Cl. H04L 1/08; H04W 72/11; H04W 72/23; H04L 5/00

(52) U.S. Cl. CPC H04L 1/08; H04W 72/11; H04W 72/23; H04L 5/0053

(57) ABSTRACT

Techniques for processing data in accordance with semi-persistent scheduling include receiving, in accordance with a mechanism for automatic retransmission of undelivered data, one or more transmissions and/or retransmissions of data associated with a periodically-scheduled occasion (402, 802), failing to recover data from the (re)transmissions (405, 808), and persisting the (re)transmission payload(s) (e.g., in a combined form) in a buffer corresponding to the occasion for use in future attempts at recovering the data (412, 812), e.g., persisting the payload(s) over a length of time greater than a periodicity of the occurrences of the occasion. For example, the UE may utilize a retransmission timer (412) which, while activated, prevents the persisted payload information from being overwritten or cleared, and/or the UE may reallocate the persisted payload information from being maintained in the buffer initially associated with occasion to being maintained/persisted in another buffer (812).

### CROSS-REFERENCE TO RELATED APPLICATIONS

This application claims priority to and the benefit of U.S. Provisional Patent Application No. 63/062,262 filed on Aug. 6, 2020 and entitled “HYBRID AUTOMATIC REPEAT REQUEST PROCEDURES FOR SEMI-PERSISTENT SCHEDULED IN LATENCY SENSITIVE SYSTEMS,” and also claims priority to and the benefit of U.S. Provisional Patent Application No. 63/131,636 filed on Dec. 29, 2020 and entitled SEMI-PERSISTENT SCHEDULING IN LATENCY-SENSITIVE SYSTEMS,” the disclosures of which are hereby incorporated by reference in their entireties.

### FIELD OF THE DISCLOSURE

This document relates to wireless communications and, more particularly, to systems, methods, and techniques of processing wireless communications data in accordance with semi-persistent scheduling and by using mechanisms for automatic retransmission of unsuccessfully-delivered data.

### BACKGROUND

The background description provided within this document is for the purpose of generally presenting the context of the disclosure. Work of the presently named inventors, to the extent described in this background section, as well as aspects of the description that may not otherwise qualify as prior art at the time of filing, are neither expressly nor impliedly admitted as prior art against the present disclosure.

A base station in some cases configures a UE for hybrid automatic repeat request (HARQ) procedures in accordance with so-called semi-persistent scheduling (SPS) that generally allows the base station to send scheduling assignments or grants to UEs less frequently. The base station sends, to the UE, data via a transport block during a periodic, physical downlink shared channel (PDSCH) scheduled for a HARQ procedure or process. When the UE fails to successfully decode or otherwise recover the data included in the received transport block, the UE stores the payload of the transport block in a buffer (e.g., a “soft-buffer”) corresponding to the HARQ process and sends a negative acknowledgement to the base station. After the UE receives a retransmission of the transport block from the base station, the UE combines the payload of the retransmission with the contents of the buffer associated with the HARQ process. In other words, the base station “soft-combines” the payload of the transmission and the payload of retransmission. The base station then attempts to decode or otherwise recover the data from the soft-combination of the payloads corresponding to the transport block. When the recovery again fails or is otherwise unsuccessful, the UE sends a corresponding negative acknowledgement to the base station, stores the soft-combination of the payloads in the buffer, and awaits another, second retransmission of the transport block, the payload of which will be soft-combined with the contents of the buffer and subjected to another recovery attempt. The base station may schedule up to four retransmissions of the unsuccessfully-recovered transport block data on various time slots based on, for example, available time slots, downlink traffic load, base station processing load, and the like. For example, the base station may schedule a retransmission to occur during a subsequent occurrence of the periodically-scheduled PDSCH corresponding to the HARQ process. In some situations, the base station may dynamically schedule a retransmission of unsuccessfully-recovered transport data in between periodically-scheduled PDSCH resources corresponding to the HARQ process, e.g., prior to a next occurrence of the periodically-scheduled PDSCH corresponding to the HARQ process. In these situations, the base station may utilize downlink control information (DCI) to dynamically schedule the retransmission with the UE.

However, when the base station sends a transport block to the UE via a subsequent occurrence of the periodically scheduled PDSCH resource associated with the HARQ process, the UE processes the payload of the transport block as a new transport block, and clears and/or overwrites the contents of the buffer associated with the HARQ process and in which the previous transport block's soft-combined payload was being stored. As such, when the transport block delivered during the subsequent occurrence of the periodically scheduled PDSCH resource associated with the HARQ process is a re-transmission of the previous, unrecovered transfer block, the delivery of data included in the previous transport block may be delayed because the UE clears the previous transport block's soft-combined payload from the buffer, and as such the cleared soft-combined payload cannot be used to aid in subsequent decoding of the payload of the retransmission of the previous transport block. In some situations, the delivery of the data included in the previous transport block may be lost altogether, such as when the transport block delivered during the subsequent occurrence of the periodically scheduled PDSCH resource is indeed a new transmission of a new transport block, and the soft-combined payload of the previous transport block is cleared from the buffer and abandoned. These issues are particularly exacerbated in systems that support Time Sensitive Communications (TSC) or are otherwise are latency sensitive, in systems configured with shorter periodicities for the scheduling of PDSCHs associated with respective HARQ processes, in systems that are densely configured for semi-persistent scheduling of PDSCHs, and/or when downlink transmissions of systems are subject to deep channel fading.

A proposed solution for preventing the UE from overwriting the buffer contents associated with a first HARQ process before the corresponding transport block has been successfully decoded or recovered includes the base station signalling to the UE, e.g., via physical downlink control channel (PDCCH) resources, to skip monitoring or processing a subsequent or next periodically-scheduled SPS PDSCH resource corresponding to another HARQ process, and instead process the payload of the subsequent or next periodically-scheduled SPS PDSCH resource for the first HARQ process. The base station would then schedule the retransmission of the unsuccessfully decoded transport block by overwriting the next periodically-scheduled SPS PDSCH resource with the retransmission of the data corresponding to the first HARQ process.

However, the proposed solution also suffers from several drawbacks. For example, to maintain the PDCCH detection probability under adverse channel conditions such as deep fading, the base station would need to arrange more control channel elements (e.g., Control Chanel Elements (CCEs), time/frequency radio resources, etc.) for a PDCCH. As such, the number of available PDCCH resources may be insufficient to schedule a retransmission PDSCH that overwrites the subsequent or next periodically-scheduled SPS PDSCH. Additionally, if the base station receives a NACK from the UE corresponding to the decoding failure in a timeslot which is immediately prior to the occurrence of the subsequent or next periodically-scheduled SPS PDSCH, the base station may not have enough time to prepare the retransmission PDSCH. Further, if the base station has already scheduled a new transmission of a new transport block on the subsequent or next periodically-scheduled SPS PDSCH, the base station would need to postpone the new transmission of the new transport block until after the retransmission of the unsuccessfully-decoded transport block. Considering the decay of data values over time in latency-sensitive services, a new transmission has a higher data value drop than a retransmission and as such, postponing the new transmission in favor of the retransmission would be costlier than allowing the new transmission to proceed as scheduled.

### SUMMARY

A base station configures a User Equipment (UE) for supporting a mechanism for automatic retransmission of unsuccessfully delivered or unsuccessfully recovered data (for example, hybrid automatic repeat request (HARQ) procedures or processes, or similar) using semi-persistent scheduling (SPS), and transmits data, to the UE, via a transport block during a physical downlink shared channel (PDSCH) scheduled for a particular occasion (e.g., for a particular HARQ process or procedure). That is, the base station transmits the data to the UE during an occurrence of an occasion associated with the procedure, where the occurrences of the occasion may be periodically scheduled according to the SPS. When the UE fails to successfully recover the data from the received transmission (for example, when the UE fails to receive a medium access control layer protocol data unit (MAC PDU) associated with the transport block, when the UE fails to successfully decode the payload of the transport block, etc.), the UE stores and persists the payload of the transport block in a buffer (e.g., a soft-buffer) associated with the occasion or HARQ process and sends a negative acknowledgement to the base station. Significantly, the UE persists or retains the payload of the transport block in the buffer across one or more subsequent, periodically scheduled occurrences of the occasion. That is, the UE maintains the transport block payload within the buffer over a length of time that is greater than a length of a periodicity of the scheduled PDSCHs associated the occasion or HARQ process. In some embodiments, the SPS defines the occasions of the configuration to occur in a re-occurring order, and each occasion has the same periodicity. As such, in these embodiments, the UE may persist or retain the payload of the transport block in the buffer across scheduled occurrences of the occasion and/or of different occasions.

When the UE receives a retransmission of the transport block, the UE soft-combines the payload of the retransmission with the contents of the buffer and attempts to recover the data from the soft-combination of the payload of the retransmission and the contents of the buffer. If the recovery is unsuccessful, the UE persists the soft-combination in the buffer, sends a corresponding negative acknowledgement to the base station, and awaits another retransmission. As the UE persists the combination (e.g., soft-combination) of previously received payloads in the buffer, the UE may handle subsequent retransmissions of the transport block in a similar manner until the UE successfully recovers the data corresponding to the transport block, upon which the UE sends a positive acknowledgement to the base station.

In an example embodiment, a method in a user equipment (UE) for processing data transmitted from a base station in accordance with semi-persistent scheduling (SPS) and by using a mechanism for automatic retransmission of undelivered data may include receiving, by processing hardware of the UE, a transmission of data from the base station using the mechanism, where the transmission of the data is associated with an occasion scheduled according to the SPS. The method may additionally include, in response to a failure to recover the data included in the transmission, persisting, by the processing hardware in a buffer corresponding to the occasion, a payload of the transmission; sending, by the processing hardware, a negative acknowledgment to the base station; and activating a retransmission timer during which the UE processes one or more retransmissions of the data associated with the occasion from the base station using the mechanism. In some implementations, while the retransmission timer remains activated, the UE processes only retransmissions of the data associated with the occasion, and does not process any transmissions of new data associated with the occasion. In some implementations, the buffer in which the payload of the transmission persists is a buffer at the UE which has been assigned to exclusively support the occasion associated with an initial transmission of the data. The persisting of the transmission payload in the buffer may be over a length of time which is greater than a length of a periodicity of the occasion, where the periodicity is defined in accordance with the SPS.

In an example embodiment, a method in a user equipment (UE) for processing data transmitted from a base station in accordance with semi-persistent scheduling (SPS) and by using a mechanism for automatic retransmission of undelivered data includes receiving, by processing hardware of the UE from the base station using the mechanism, a transmission of data corresponding to an occasion scheduled according to the SPS, and determining a first occasion identifier corresponding to the occasion and associated with a first buffer at the UE. The method may additionally include, in response to a failure to recover the data included in the transmission, sending, by the processing hardware, a negative acknowledgment to the base station and, based on an association between the first occasion identifier and a second occasion identifier, persisting, by the processing hardware, a payload of the transmission in a second buffer associated with the second occasion identifier. The first buffer may have been assigned to exclusively support the occasion identified by the first occasion identifier, for example. The second buffer may have been assigned to exclusively support a second occasion identified by the second occasion identifier, or the second buffer may be an unused or arbitrary buffer, for example. The persisting of the transmission payload in the second buffer may be over a length of time greater than a length of a periodicity of the occasion corresponding to the received transmission, where the periodicity is defined in accordance with the SPS.

Accordingly, as the UE persists unsuccessfully-recovered transport block payload (e.g., in an initial and/or soft-combined form) over one or more subsequent periodically-scheduled occurrences of an occasion in a buffer associated with the occasions rather than prematurely clearing or abandoning the unsuccessfully-recovered transport block payload from the buffer, the techniques of this document decrease the latency of downlink data delivery. In particular, the techniques of this document decrease downlink data delivery latency in systems which provide latency-sensitive services, support Time-Sensitive Communication (TSC), are densely configured for semi-persistent scheduling of PDSCHs, are configured for shorter periodicity intervals, are subject to undesirable channel conditions (such as deep fading), and/or deliver transport blocks including larger sizes of data payload, for example, transport block sizes of 32 to 250 bytes or transport block sizes of 4096 bytes to 10,000 kB.

### BRIEF DESCRIPTION OF THE DRAWINGS

FIG. 1 depicts an example wireless communication system in which devices such as base stations and User Equipments (UEs) communicate data, where the system supports processing data transmitted from a base station using semi-persistent scheduling (SPS) and a mechanism for automatic retransmission of unsuccessfully-delivered data, in accordance with at least some of the principles and techniques disclosed in this document.

FIG. 2 depicts a prior art message flow between a base station and a UE, where the message flow includes retransmissions of unsuccessfully delivered or unsuccessfully recovered data.

FIG. 3 depicts an example message flow between a base station and a UE, where the message flow includes retransmissions of unsuccessfully delivered or unsuccessfully recovered data and utilizes a retransmission timer, in accordance with at least some of the principles and techniques disclosed within this document.

FIG. 4 depicts a flow diagram of an example method for processing data transmitted from a base station in accordance with semi-persistent scheduling and by using a mechanism for automatic retransmission of unsuccessfully delivered data and a retransmission timer, in accordance with at least some of the principles and techniques disclosed within this document.

FIG. 5 depicts a prior art message flow between a base station and a UE, where the message flow includes retransmissions of unsuccessfully delivered or unsuccessfully recovered data.

FIG. 6 depicts another prior art message flow between a base station and a UE, where the message flow includes retransmissions of unsuccessfully delivered or unsuccessfully recovered data.

FIG. 7 depicts an example message flow between a base station and a UE, where the message flow includes retransmissions of unsuccessfully delivered or unsuccessfully recovered data and utilizes a reallocation occasion and/or reallocation buffer, in accordance with at least some of the principles and techniques disclosed within this document.

FIG. 8 depicts a flow diagram of an example method for processing data transmitted from a base station in accordance with semi-persistent scheduling and by using a mechanism for automatic retransmission of unsuccessfully delivered data and a reallocation occasion and/or reallocation buffer, in accordance with at least some of the principles and techniques disclosed within this document.

### DETAILED DESCRIPTION

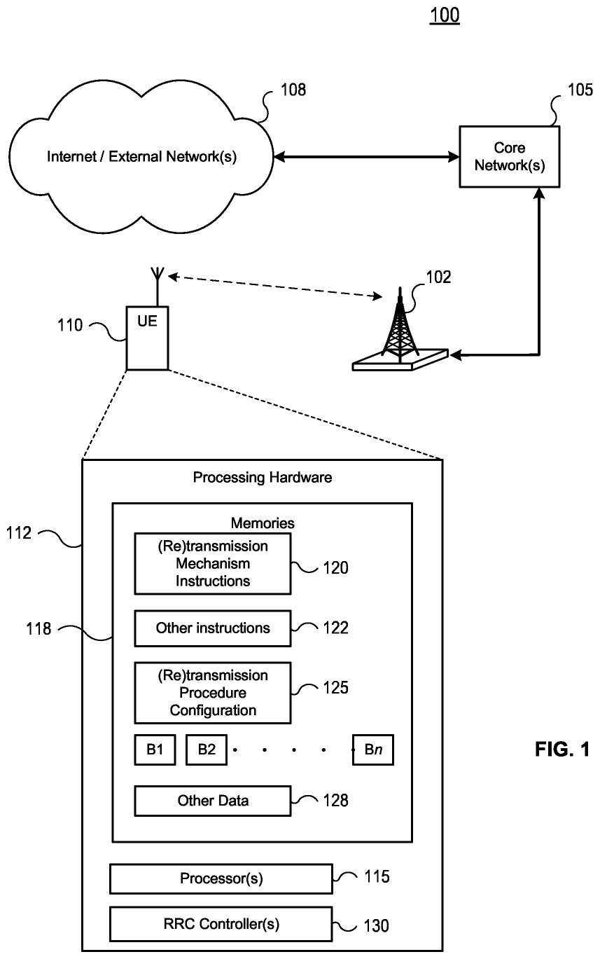

FIG. 1 depicts an example wireless communication system 100 in which devices such as base stations and User Equipments (UEs) communicate data, and that supports the systems, methods, and techniques of this document. The wireless communication system 100 includes one or more base stations 102, which FIG. 1 depicts by a single base station representation, and which this document discusses using the singular tense for ease of discussion (and not for limitation purposes). The base station 102 supports a Radio Access Network (RAN) of a particular Radio Access Technology (RAT), such as NR (New Radio). The base station 102 communicatively connects to one or more types of core networks (CNs) 105 (e.g., SGC, EPC, etc.), which in turn communicatively connect to the Internet and/or any number of other networks 108, which may include one or more private and/or public networks 108. Similar to depiction of the base station 102, FIG. 1 depicts the one or more core networks 105 using a single core network representation, and this document discusses the one or more CNs 105 using the singular tense for ease of discussion (and not for limitation purposes).

A User Equipment (UE) 110, which can be any suitable device capable of wireless communications via one or more types of RANs, can communicatively connect with the wireless communication system 100 via the base station 102. The UE 110 includes processing hardware 112 that can include one or more processors (e.g., CPUs) 115 and one or more non-transitory, tangible, computer-readable memories 118 storing computer-executable instructions that the one or more processors 115 read and/or execute. Particularly, the instructions include transmission/retransmission mechanism instructions 120 (which, for ease of reading, this document also refers to as “(re)transmission” mechanism instructions 120) for processing data which is delivered by the base station 102 to the UE and unsuccessfully recovered by the UE, in accordance with one or more of the methods, principles, and techniques disclosed in this document. The memories 118 can also store other instructions 122, in embodiments. In an example implementation of the UE 110, the one or more processors 115 execute the computer-executable instructions 120, 122 to perform any one or more of the portions of the described methods and/or techniques. In some implementations, the one or more processors 115 execute the computer-executable instructions 120, 122 to operate in conjunction with firmware and/or other portions of the processing hardware 112 to perform any one or more of the portions of the described methods and/or techniques.

Additionally, the memories 118 of the UE 110 can store data utilized to perform any one or more of the portions of the methods and/or techniques described within this document. In particular, the memories 118 store a transmission/retransmission mechanism configuration 125 (e.g., a “(re)transmission” mechanism configuration 125, as referred to within this document for ease of reading) and a plurality of buffers B1-Bn associated with the described methods and/or techniques. Typically, the (re)transmission mechanism configuration 125 defines or indicates a total number of occasions of a mechanism for automatic retransmission of unsuccessfully recovered data utilized by the base station and the UE. The (re)transmission mechanism configuration 125 may include respective identifiers for the occasions, for example. In an embodiment, the mechanism may include Hybrid Automatic Repeat Request (HARQ) processes or procedures and corresponding HARQ identifiers (IDs). Each retransmission occasion may be scheduled to occur periodically, in an embodiment, and the periodicities of the occurrences of occasions and an order of the periodic occurrences of the occasions may be defined in accordance with semi-persistent scheduling (SPS). For example, the configuration 125 may define eight occasions, and the eight occasions may be scheduled to periodically occur in accordance with SPS in a sequential manner, e.g., Occasion 1, Occasion 2, . . . , Occasion 7, Occasion 8, Occasion 1, Occasion 2, . . . , and so on. Thus, as utilized within this document, a “periodicity” of an occasion n is based on the fixed or constant time interval elapsing between each scheduled occurrence of the occasion n and the next (or immediately following) scheduled occurrence of the occasion n. Further, in some implementations, the time interval elapsing between scheduled occurrences of any two sequentially occurring occasions (e.g., between scheduled occurrences of occasion n and occasion n+1) may be a fixed or constant time interval.

The base station 102 transmits the (re)transmission configuration 125 to the UE 110 during connection setup procedures to thereby configure the UE 110 for the (re)transmission mechanism. The UE 110 allocates a respective buffer B1-Bn for each occasion indicated in the configuration 125 to utilize in recovering data which the base station sends to the UE. For example, when the configuration 125 indicates or defines n different occasions, the UE 110 allocates n different buffers, each of which corresponds to a respective occasion of the mechanism. Typically, but not necessarily, n may be an integer between 1 and 16. The UE 110 may utilize the buffers B1-Bn for decoding the payload of transmissions received via the mechanism during the different n occasions. As such, the buffers B1-Bn may be soft buffers. Of course, the memories 118 may store other data 128 in addition to the (re)transmission mechanism configuration 125 and the buffers B1-Bn. The UE 110 may utilize the stored data 125, 128 and one or more of the buffers B1-Bn while performing one or more of the portions of the described methods and/or techniques.

Further, the example processing hardware 112 includes one or more Radio Resource Control (RRC) controllers 130 used to communicate Radio Frequency (RF) signals with the base station 102 via radios in accordance with one or more different types of RATs supported by the UE 110. The RF signals may include or transport data and/or other signals delivered between the UE 110 and the base station 102 via the uplink and the downlink. At least some of the downlink RF signals include data delivered from the base station 102 to the UE 110 in accordance with semi-persistent scheduling (SPS).

For example, the base station 102 prepares a transport block including, as payload, data that is to be delivered to the UE 110, and delivers the transport block to the UE 110 during an occurrence of occasion which is scheduled to periodically occur in accordance with the SPS, e.g., during respective periodically scheduled PDSCHs (e.g., a HARQ process or procedure). The periodically occurring occasion may be referenced or utilized via its identifier, for example, during automatic retransmissions of unsuccessfully recovered downlink data. If the data included in the transmission is not successfully delivered to and/or recovered by the UE 110, the base station 102 may schedule a retransmission of the unrecovered data during a subsequent scheduled occurrence of the occasion, during an occurrence of another periodically scheduled occasion, or between periodically scheduled occurrences of occasions, e.g., in an non-periodic manner, as is described in more detail elsewhere in this document.

Generally speaking, when the UE 110 fails to successfully decode or otherwise recover data included in a transport block sent from the base station 102 during a PDSCH corresponding to a particular occasion, the UE 110 stores the payload of the transmission in a local buffer Bi associated with the particular occasion, e.g., in a corresponding one of the buffers B1-Bn. Upon receiving a retransmission of the transport block from the base station 102 (which may indicate the identifier of the particular occasion), the UE 110 combines (e.g., soft-combines) the payload of the retransmission with the contents of the buffer Bi, and attempts to recover the data from the combined information. If recovery of the data is again unsuccessful, the UE 110 stores the combined information in the buffer Bi and waits for another retransmission of the transport block. Significantly, the UE 110 may persist the combined information corresponding to the particular occasion in the buffer Bi over a duration of time which exceeds a periodicity of the particular occasion, so that a subsequent occurrence of the periodically-scheduled PDSCH for the particular occasion does not result in the payload(s) of the earlier (re)transmissions of the transport block being overwritten, deleted, or lost to the UE 110. Accordingly, as the UE 110 persists the payloads of the initial and subsequent transmission(s) in the buffer Bi, e.g., in a soft-combined format, the combined payloads are available to the UE to use with payloads of future retransmissions in attempts to decode and recover the data. As such, latency in delivering the data decreases as compared to current retransmission techniques, as each subsequent attempt to recover the data may take advantage of the persisted, previously-received information to aid in data recovery. Indeed, the techniques described in this document are particularly useful in reducing data delivery latency in systems in which SPS periodicities are reduced, e.g., to less than 10 milliseconds, less than 5 milliseconds, or less than 1 millisecond.

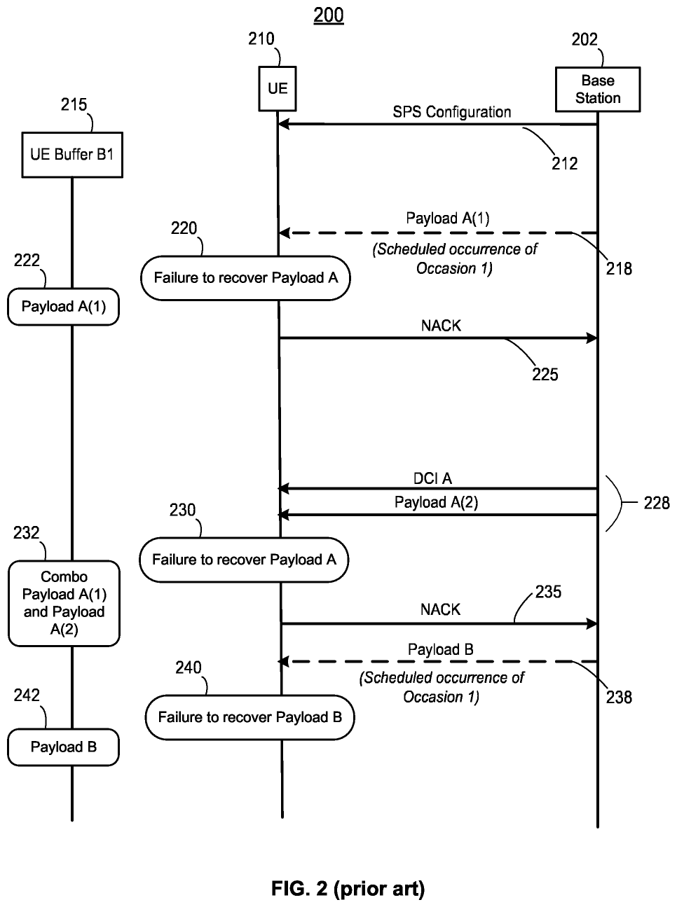

To illustrate, FIG. 2 depicts a prior art message flow 200 in which the payloads of one or more (re)transmissions of unsuccessfully delivered or unsuccessfully recovered data are lost to a UE 210, thereby contributing to the latency of the delivery of the data from a base station 202 to the UE 210. In the message flow 200, the base station 202 configures the UE 210 (as denoted by reference 212) with an SPS configuration indicating a total number of occasions corresponding to automatic retransmissions of unsuccessfully delivered or unsuccessfully recovered data, and the UE 210 allocates a different buffer for each occasion. For clarity purposes, FIG. 2 shows only one of the buffers B1-Bn, e.g., buffer B1 denoted by reference 215, where the buffer B1 corresponds to a first occasion, e.g., Occasion 1. Similarly, for clarity purposes, FIG. 2 does not illustrate scheduled occurrences of occasions other than those of Occasion 1.

During operations, the base station 202 sends an initial transmission of data to the UE 210 during a scheduled occurrence of Occasion 1 (reference 218), e.g., during a PDSCH utilized to service periodically scheduled occurrences of Occasion 1, which this document generally refers to as a “scheduled” PDSCH. The UE 210 fails to successfully recover the data 220 from the initial transmission 218 and, as such, stores the payload of the initial or first transmission, e.g., “Payload A(1),” in the buffer B1 corresponding to Occasion 1 (reference 222) for use in aiding in future decoding or data recovery attempts, and sends a negative acknowledgement or NACK 225 to the base station.

In response to the NACK 225, the base station 202 retransmits the data of the transport block to the UE 210 in between periodically scheduled occurrences of Occasion 1 (reference 228). In particular, the base station 202 informs the UE 210 (e.g., via downlink control information (DCI) transmitted on a Periodic Downlink Control Channel resource) of an impending retransmission of Payload A on an assigned PDSCH resource, and the base station 202 retransmits the data of the transport block (e.g., “Payload A(2)”) during the assigned PDSCH (reference 228). An “assigned” PDSCH, as utilized within this document, generally refers to a PDSCH which is not utilized to service periodically scheduled occurrences of Occasion 1, but instead is assigned by the base station 202 to service a non-periodic retransmission associated with Occasion 1. Upon receiving the retransmission via the assigned PDSCH 228, the UE 210 combines the payload of the retransmission 228 with the contents of the buffer B1, and attempts to recover the data from the combination. For example, the UE 210 soft-combines Payload A(2) of the retransmission 228 with Payload A(1) stored in the buffer B1 (reference 222), and the UE 210 attempts to recover the data from the soft-combination of Payload A(1) and Payload A(2). In the message flow 200, the UE 210 again fails to recover the data from the combination of Payload A(1) and Payload A(2) (reference 230) and, accordingly, stores the combination of Payload A(1) and Payload A(2) in the buffer B1 (reference 232) for use in future decoding attempts and returns a corresponding negative acknowledgement or NACK 235 to the base station 202.

However, in the scenario illustrated in FIG. 2, the base station 202 is not able to prepare and send another retransmission of Payload A in response to the NACK 235, as the base station 202 has already scheduled an initial or first transmission of new data (e.g., “Payload B”) to the UE 210 during the next, scheduled periodic occurrence of Occasion 1, as denoted by reference 238. Such situations may easily arise when the periodicity of Occasion 1 is of a shorter duration (e.g., less than 10 ms, less than 5 ms, less than 1 ms, etc.). In this scenario, UE 210 automatically treats each occurrence of the Occasion 1 as an initial transmission of new data. Thus, when the UE 210 fails to successfully recover the new data from the transmission 238 (reference 240), the UE 210 stores the payload of the transmission 238 in the buffer B1 corresponding to Occasion 1 (reference 242). That is, the UE 210 overwrites the combination of Payload A(1) and Payload A(2) which had been stored in the buffer B1 (reference 232) with the Payload B (reference 242).

As such, the combination of Payload A(1) and Payload A(2) is no longer available to the UE 210 for use in decoding subsequent retransmissions of Payload A. Consequently, when the base station 202 eventually schedules and sends another retransmission of Payload A to the UE 210 in response to the NACK 235, the UE 210 must start from a blank slate to recover the data of Payload A, perhaps again with multiple retransmissions, as the previously received information (e.g., the combination of Payload A(1) and Payload A(2)) is no longer available to the UE 210 for use in decoding the payload of the retransmissions. As such, the latency or delay in delivering the Payload A from the base station 202 to the UE 210 may significantly increase. This undesirable situation is more likely to occur not only in systems having shorter periodicities of occasions, but also when the UE 210 is subject to deep channel fading or significant interference, thereby increasing the chances of unsuccessful data recovery and thus requiring more retransmissions.

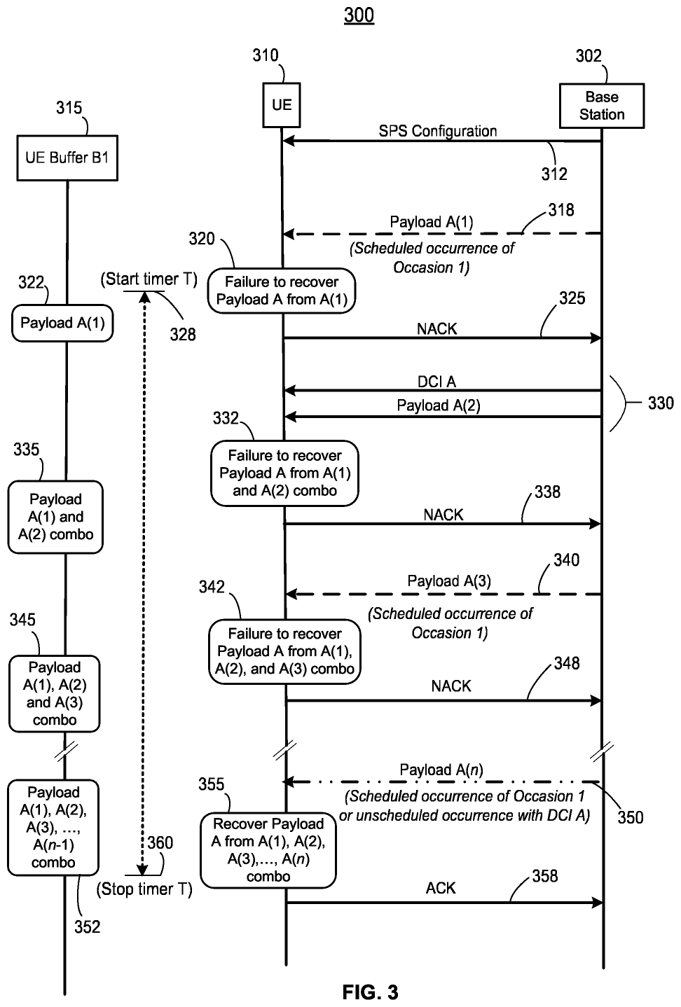

On the other hand, FIG. 3 illustrates an example message flow 300 in which the UE maintains or persists payloads of one or more (re)transmissions of unsuccessfully delivered or unsuccessfully recovered data transmitted from a base station 302, thereby decreasing the latency of the delivery of the data. In an embodiment, the system 100 of FIG. 1 may implement the message flow 300. For example, the base station 302 may be the base station 102 of the system 100, and the UE 310 may be the UE 110 of the system 100. Of course, the message flow 300 may be implemented by systems, base stations, and/or UEs other than those illustrated in FIG. 1.

In the message flow 300, and in a manner similar to FIG. 2, the base station 302 configures the UE 310 (reference 312) with an SPS configuration which indicates a total number of occasions corresponding to automatic retransmissions of unsuccessfully delivered or unsuccessfully recovered data, and the UE 310 allocates a different buffer for each occasion. Also similar to FIG. 2 and for clarity purposes, FIG. 3 shows only one of the buffers B1-Bn, e.g., buffer B1 corresponding to Occasion 1, denoted by reference 315. Additionally, for clarity purposes, FIG. 3 does not illustrate periodically scheduled occurrences of occasions other than those of Occasion 1.

Further similar to FIG. 2, during operations, the base station 302 sends an initial transmission of data to the UE 310 during a periodically scheduled occurrence of Occasion 1 (reference 318), e.g., during a scheduled PDSCH utilized for periodically scheduled occurrences of Occasion 1. The UE 310 fails to successfully recover the data 320 from the initial transmission 318. Accordingly, the UE 310 stores the payload of the initial or first transmission of the data, e.g., “Payload A(1),” in the buffer B1 (reference 322), and returns a negative acknowledgement or NACK to the base station 302 (reference 325).

However, in the message flow 300, based on the failure to successfully recover the data from the initial transmission 318 (reference 320), the UE 310 starts or activates a retransmission timer T (reference 328). For example, the UE 310 may start or activate the retransmission timer T (reference 328) upon failing to recover the data 320 from the initial transmission during the occurrence of Occasion 1 (reference 318), upon storing the Payload A(1) in the buffer B1 associated with Occasion 1 (reference 322), or upon transmitting the NACK 325 to the base station 302. The retransmission timer T indicates a duration of time over which the contents of the buffer B1 corresponding to Occasion 1 are to be persisted in buffer B1 at the UE 310 and are not to be deleted or overwritten. In particular, while the retransmission timer T is active, the UE 310 continues to process retransmissions received with respect to Occasion 1 in conjunction with the persisted contents of buffer B1, and does not overwrite or clear the contents of the buffer B1. The length of the retransmission timer T may be configured, e.g., within the (re)transmission configuration data 125, and may be adjustable. For example, during procedures for setting up the connection between the base station 302 and the UE 310, or during procedures for reconfiguring the connection, the base station 302 may configure the UE 310 with a duration of the retransmission timer T, or the UE 310 may inform the base station 302 of the duration of the retransmission timer T.

At any rate, continuing with the example message flow 300, in response to the negative acknowledgement 325, the base station 302 retransmits the data of the transport block to the UE 310 in between periodically scheduled occurrences of Occasion 1. As shown in FIG. 3, the base station 302 informs or signals the UE 310 (e.g., via a DCI on a PDDCH resource) of an upcoming, non-periodic retransmission of Payload A, and follows the DCI signal with the retransmission of the data of the transport block (e.g., “Payload A(2)”) via an assigned PDSCH (reference 330). As the retransmission timer T is still active, the UE 310 combines the payload of the retransmission 330 with the contents of the buffer B1, and attempts to recover the data from the combination. For example, the UE 310 soft-combines Payload A(2) of the retransmission 330 with Payload A(1) stored in the buffer B1 (reference 322), and the UE 310 attempts to recover the data (e.g., Payload A) from the soft-combination of Payload A(1) and Payload A(2). In the scenario depicted in message flow 300, the UE 310 again fails to recover the data from the combination of Payload A(1) and Payload A(2) (reference 332). As the retransmission timer T is still active, the UE 310 stores the combination of Payload A(1) and Payload A(2) in the buffer B1 (reference 335) and returns a corresponding negative acknowledgement or NACK 338 to the base station 302.

Further, and significantly, as the base station 302 and the UE 310 have been configured to operate in accordance with the retransmission timer T, and because the base station 302 receives the NACK 338 corresponding to Payload A associated with Occasion 1, the base station 302 does not schedule any initial transmissions of new data during future scheduled occurrences of Occasion 1. Accordingly, upon the next scheduled occurrence of Occasion 1, the base station 302 again retransmits Payload A (e.g., “Payload A(3)”) to the UE 310 (reference 340) and does not transmit any new data.

As the retransmission timer T is still active, the UE 310 combines the payload of the retransmission 340 with the current contents of the buffer B1 (reference 335), and attempts to recover the data from the combination. For example, the UE 310 soft-combines Payload A(3) of the retransmission 340 with soft-combination of Payload A(1) and Payload A(2) stored in the buffer B1 (reference 335), and the UE 310 attempts to recover the data from the soft-combination of Payload A(1), Payload A(2), and Payload A(3). In the scenario shown in message flow 300, the UE 310 again fails to recover the data from the combination of Payload A(1), Payload A(2), and Payload A(3) (reference 342). As the retransmission timer T is still active, the UE 310 stores the combination of Payload A(1), Payload A(2), and Payload A(3) in the buffer B1 (reference 345) and returns a corresponding negative acknowledgement or NACK 348 to the base station 302.

At some subsequent time, the base station 302 again retransmits Payload A (e.g., “Payload A(n)”) to the UE 310 (reference 350), e.g., either during another scheduled PDSCH corresponding to Occasion 1, or during an assigned PDSCH in conjunction with a DCI. The UE 310 combines the payload of the retransmission 350 with the current contents of the buffer B1 (reference 352), and attempts to recover the data from the combination. For example, the UE 310 soft-combines Payload A(n) of the retransmission 350 with soft-combination of Payload A(1), Payload A(2), Payload A(3), . . . , Payload A(n−1) stored in the buffer B1 (reference 352), and attempts to recover the data of the initial transmission 318 from the soft-combination. This time, the UE 310 successfully recovers Payload A of the initial transmission 318 (reference 355), and the UE 310 informs the base station 302 of the successful data recovery via a positive acknowledgement or ACK 358. Additionally, due to the successful data recovery 355, the UE 310 stops or deactivates the retransmission timer T (reference 360), e.g., upon completing the successful recovery 355 or upon sending the ACK 358. As such, the UE may utilize the buffer B1 with respect to other data, if needed. Indeed, in some embodiments, the UE 310 may clear the contents of the buffer B1 upon sending the ACK 358 and/or upon deactivating the retransmission timer T (reference 360). Further, because the base station 302 receives the ACK 358 indicating the successful recovery of Payload A, the base station 302 may schedule initial transmissions of new data during scheduled re-occurrences of Occasion 1.

In the example message flow 300, the UE 310 stops or deactivates the retransmission timer T (reference 360) upon successfully recovering the data of the initial transmission (reference 355) and/or upon transmitting the positive acknowledgement of the successful recovery 358 to the base station 302. In other scenarios, though (not shown in FIG. 3), the UE 310 may not be able to successfully recover the data of the initial transmission block prior to expiration of the retransmission timer T. Accordingly, in these scenarios, upon expiration of the retransmission timer T, the UE 310 may clear the content of the buffer B1 so the buffer B1 may be freed up for other purposes, and/or the UE 310 may begin processing new or other data which the UE receives via the associated occasion and possibly storing new or other payloads in the buffer B1, e.g., by overwriting any contents of buffer B 1. As such, the length or duration of the retransmission timer T corresponds to a maximum waiting time for successfully delivering a particular block of data, e.g., an upper bound. For example, as shown in the example message flow 300 of FIG. 3, the length or duration of the retransmission timer T is greater than the length or duration of the periodicity of Occasion 1. This bounding of the waiting time is particularly important within latency-sensitive systems as, over time, the drop of a data value per unit delay decreases, so that at some point along the time-data value curve, processing a new transmission is more valuable than postponing the new transmission to process a retransmission. The length or duration of the retransmission timer may correspond to this point along the time-data value curve. For example, the length or duration of the retransmission timer T may correspond to a configuration of the SPS (e.g., as defined in the configuration 125), a current or expected traffic load, a current or expected processing load of the UE 310 and/or of the base station 302, a channel condition, and/or other conditions which may affect latency. In some embodiments, the length or duration of the retransmission timer T may be tuned to one or more latency-affecting conditions. Indeed, in some embodiments, the retransmission time may be responsively and/or dynamically adjusted or tuned to changing latency-affecting conditions. For example, the UE 310 may adjust the duration of the retransmission timer T and inform the base station 302, and/or the base station 302 may adjust the duration of the retransmission timer T and inform the UE 310.

In some embodiments of the message flow 300, the UE 310 stops or deactivates the retransmission timer T (reference 360) after the UE 310 has received a maximum number of retransmissions which the UE 310 has not been able to successfully recover, for example, four unsuccessfully recovered retransmissions, six unsuccessfully recovered retransmissions, etc. As such, when such scenarios occur, the UE 310 deactivates the retransmission timer T and may clear the content of the buffer B1 so the buffer B1 is freed up for other purposes, and/or the UE 310 may begin processing new or other data which the UE receives via the associated occasion and possibly storing new or other payloads in the buffer B1, e.g., by overwriting any contents of buffer B 1. The maximum number of unsuccessfully recovered retransmissions may be pre-defined, and may be adjustable. The UE 310 may or may not inform the base station 302 that the UE 310 has deactivated the retransmission timer T.

In some embodiments, UE 310 may utilize multiple retransmission timers. For example, each buffer B1, . . . , Bn may be associated with a respective retransmission timer. Each retransmission timer may have a same duration, or at least some of the multiple retransmission timers may have different durations. For example, different retransmission timers of different durations may be associated with different types of message payloads having different Quality of Service (QoS) requirements (e.g., as indicated by the network), such as priorities, latency requirements, target bit error rates, and/or other criteria.

In some embodiments of the message flow 300, the UE 310 may start or activate the retransmission timer T (reference 328) at a different point in time within the message flow 300. For example, instead of the UE 310 activating the retransmission timer T (reference 328) upon the failure to recover Payload A from a first or initial transmission (e.g., corresponding to reference 318 and 320 as shown in FIG. 3), the UE 310 may activate the retransmission timer T (reference 328) upon a subsequent failure to recover Payload A from a later retransmission (e.g., corresponding to references 330 and 332, or to references 340 and 342).

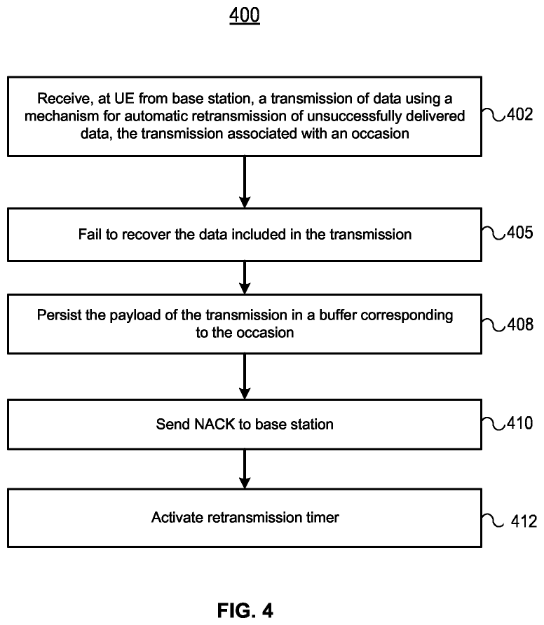

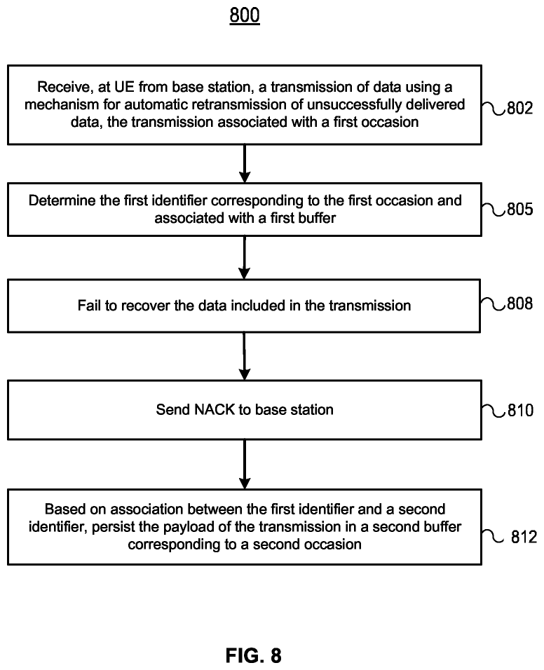

FIG. 4 depicts a flow diagram of an example method 400 for processing data transmitted from a base station in accordance with semi-persistent scheduling and by using a mechanism for automatic retransmission of unsuccessfully delivered data and a retransmission timer, in accordance with at least some of the principles and techniques disclosed within this document. At least a portion of the method 400 may be performed by a UE. In an example implementation, the UE is the UE 110 of FIG. 1, and the UE 110 performs at least a portion of the method 400 by executing the (re)transmission instructions 120 and optionally other instructions 122. In an example implementation, the UE is the UE 310 of FIG. 3 or another UE. In some embodiments, at least a portion of the method 400 may be executed in conjunction with at least portions of one or more other methods described within this document. For example, at least a portion of the method 400 may be executed in conjunction with at least a portion of the method 800 of FIG. 8, and/or in conjunction with at least a portion of the message flow 300 of FIG. 3. In some embodiments, the method 400 includes one or more alternate and/or additional actions other than those shown in FIG. 4. For ease of discussion, and not for limitation purposes, though, this document discusses the method 400 with simultaneous reference to the wireless communication system 100 of FIG. 1 and to the example message flow 300 of FIG. 3, although the method 400 may execute in other wireless communication systems and/or by utilizing other message flows.

The UE executing the method 400 and the base station which transmits data to the UE may be configured to operate in conjunction with a retransmission timer associated with the mechanism for automatic retransmission for unsuccessfully delivered data. For example, the base station may configure the UE with a (re)transmission procedure configuration 125 which includes a configuration of one or more retransmission timers, such as denoted by reference 312 of FIG. 3. The one or more retransmission timers may include the retransmission timer T of FIG. 3, for example.

At a block 402, the method 400 includes receiving, by processing hardware of the UE, a transmission of data from the base station using the mechanism, where the transmission of the data is associated with a periodic occurrence of an occasion scheduled according to the SPS. The occasion may be included in a set of occasions defined by the configuration 125. In an embodiment, the set of occasions may be a set of HARQ processes or procedures, where each HARQ procedure is periodically scheduled in accordance with the SPS and associated with a respective PDSCH. Typically, the periodicities of the occurrences of the occasions included in the configured set have relatively short durations, such as less than or equal to ten milliseconds, less than or equal to five milliseconds, or even less than or equal to one millisecond.

In an embodiment, receiving the transmission of data 402 includes receiving an initial transmission of the data from the base station to the UE. As such, in this embodiment, the occurrence of the occasion associated with the received initial transmission corresponds to a scheduled PDSCH, and the method 400 includes attempting to recover the data from the received initial transmission (not shown in FIG. 4).

In another embodiment, receiving the transmission of data 402 includes receiving a retransmission of data which was previously transmitted from the base station to the UE and was unsuccessfully recovered. The retransmission 402 may be delivered from the base station to the UE during another periodically scheduled occurrence of the occasion associated with the initial transmission of the data (e.g., references 340, 350 of FIG. 3), or during some assigned time slot or assigned PDSCH (e.g., references 330, 350 of FIG. 3). At any rate, in this embodiment, the method 400 includes combining the payload of the received retransmission 402 with the current contents of a buffer (e.g., a soft buffer) corresponding to the occasion associated with the received transmission, and attempting to recover the data of the initial transmission from the combination (not shown). For example, the method 400 may include soft-combining the payload of the retransmission 402 with the current contents of the buffer, and attempting to recover the data of the initial transmission from the soft-combination.

At a block 405, the method 400 includes failing to recover the data included in the received transmission, whether by processing the received payload singularly (e.g., when the received transmission 402 is an initial transmission) or by processing the received payload in combination with previously received payload(s) (e.g., when the received transmission 402 is a retransmission). The failure may be due to, for example, a discovery of corruption in the data or payload, a failure to decode the data or payload, a failure to decode a combination of the payload of the transmission and data previously stored in the buffer, and/or a failure to receive a medium access control layer protocol data unit (MAC PDU) corresponding to the transmission. Of course, other conditions may additionally or alternatively cause the failure.

Based on failing to successfully recover the data included in the received transmission (block 405), the method 400 includes persisting, by the processing hardware in a buffer corresponding to the associated occasion, the payload of the transmission (block 408); sending, by the processing hardware, a corresponding negative acknowledgment (NACK) to the base station (block 410); and activating a respective retransmission timer during which the UE processes one or more retransmissions of the data associated with the occasion from the base station using the mechanism (block 412), and does not process any new transmissions of new data associated with the occasion.

For example, with particular respect to block 408, when the received transmission 402 is an initial transmission of the data, persisting the payload of the transmission in the buffer 408 includes storing the payload of the initial transmission in the buffer. On the other hand, when the received transmission 402 is a retransmission of previously transmitted and unsuccessfully recovered data, persisting the payload of the transmission in the buffer 408 includes storing a combination (e.g., a soft-combination) of the payload of the retransmission and the previously stored or persisted contents of the buffer as updated contents of the buffer. Whether initial transmission or retransmission, though, in some scenarios, persisting the payload of the transmission in the buffer 408 includes persisting the payload of the transmission in the buffer over a length of time greater than the periodicity of occurrences of the occasion. For example, referring to FIG. 3, the method 400 may persist Payload A (and various combinations of retransmission of Payload A) in the buffer 315 over a length of time greater than the interval of time between scheduled occurrence 318 of Occasion 1 and scheduled occurrence 340 of Occasion 1.

With particular respect to block 410, sending the NACK to the base station may include sending an indication of the occasion (e.g., an occasion identifier) in conjunction with the NACK. Upon receiving the NACK, and as the base station and the UE have been configured to operate in accordance with the retransmission timer, the base station reschedules or otherwise plans for a retransmission of the data to the UE, e.g., via a periodically scheduled occurrence of the occasion, or during an assigned time slot or assigned PDSCH). Indeed, so long as the UE sends, to the base station, a NACK associated with a retransmission, the base station does not schedule any other (e.g., any new) data to be delivered via the occasion corresponding to the initial transmission.

With particular respect to the block 412, activating the retransmission timer may include activating or starting a retransmission timer, such as retransmission timer T of FIG. 3. As previously discussed, the duration of the retransmission timer may be configurable and/or dynamically tunable. Additionally, the activated retransmission timer may exclusively correspond to the buffer associated with the occasion, or may be an instance of a retransmission timer which may be utilized for more than one buffer. As previously discussed, activating the retransmission timer may occur in conjunction with failing to recover the data (block 405), storing the payload of transmission into the buffer corresponding to the occasion (block 408), or sending the NACK to the base station (block 410).

In some embodiments (not shown in FIG. 4), the method 400 further includes deactivating, by the processing hardware of the UE, the retransmission timer upon successfully recovering a content of the buffer associated with the occasion, e.g., in a manner such as previously discussed with respect to reference 360 of FIG. 3. For example, the method 400 may further include, subsequent to activating the retransmission timer 412, successfully recovering the data from a combination of the current content of the buffer corresponding to the occasion and a payload of a retransmission; deactivating the retransmission timer based on the successful recovery of the data; and transmitting, by the processing hardware of the UE, a positive acknowledgement to the base station, e.g., in a manner similar to references 352, 358, 360 of FIG. 3. The method 400 may include clearing any contents of the buffer corresponding to the occasion in conjunction with the successful data recovery, in embodiments.

In some embodiments (not shown in FIG. 4), the method 400 further includes clearing, by the processing hardware of the UE, any contents of the buffer in response to an expiration or a deactivation of the retransmission timer and, based on the clearing, optionally signaling, to the base station by the processing hardware of the UE, that the buffer has been cleared and therefore the base station may schedule other (e.g., new) data to be delivered via the occasion corresponding to the initial transmission. For example, the method 400 may include deactivating, by the processing hardware of the UE, the retransmission timer after a maximum number of retransmission attempts have been received at the UE and unsuccessfully recovered, e.g., in a manner similar to that discussed with respect to FIG. 3.

In some embodiments, the method 400 may include, after transmitting the positive acknowledgement to the base station indicating a successful data recovery, or after clearing the content of the buffer in response to an expiration of the retransmission timer, receiving, by the processing hardware of the UE from the base station using the mechanism and during another periodically scheduled occurrence of the occasion associated with the buffer, an initial transmission of new data, failing to recover the new data from its initial transmission, and storing a payload of the initial transmission of the new data in the buffer associated with the occasion, e.g., by overwriting any content of the buffer corresponding to the occasion with a payload of the initial transmission of the new data. In these embodiments, the method 400 may further include reactivating the retransmission timer upon at least one of: failing to recover the new data included in the initial transmission and/or failing to receive a medium access control layer protocol data unit (MAC PDU) corresponding to the initial transmission of the second data.

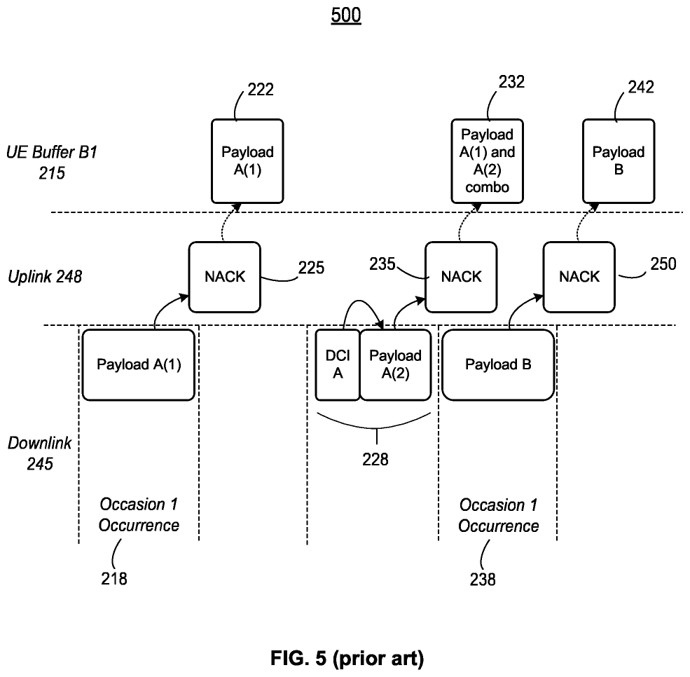

Turning now to FIG. 5, FIG. 5 depicts the scenario of the prior art message flow 200 of FIG. 2 using a different representation 500 in which time advances from left to right. FIG. 5 depicts the downlink 248 via which the base station delivers signaling and payload 218, 228, 238 to the UE (e.g., which includes both the PDDCH and PDSCHs), and the uplink 248 via which the UE sends signaling 225, 235, 250 to the base station. As shown in FIG. 5, and as previously discussed with respect to FIG. 2, the base station sends an initial transmission of data to the UE via an occurrence 218 of a periodically scheduled occasion (e.g., Occasion 1). The UE fails to successfully recover the data from the initial transmission 218, and consequently stores the payload of the initial transmission 218 (e.g., Payload A(1)) in the buffer B1 associated with Occasion 1 (references 215, 222) and sends a NACK 225 to the base station. In response to the NACK 225, the base station retransmits Payload A to the UE during an assigned PDSCH after signaling the UE as such with a corresponding DCI (reference 228). The UE combines (e.g., soft-combines) the payload of the retransmission 228 (e.g., Payload A(2)) and the current contents of the buffer B1 (reference 222), and attempts to recover the data from the combination which, in this scenario 500, is unsuccessful. As such, the UE indicates to the base station via NACK 235 that the data recovery based on the retransmission 228 was unsuccessful, and the UE stores the combination of Payload A(1) and Payload A(2) in the buffer B1 (references 215, 232). However, the base station is not able to prepare and send another retransmission of Payload A in response to the NACK 235 as the base station 202 has already scheduled an initial or first transmission of new data (e.g., “Payload B”) to the UE during the next, scheduled periodic occurrence of Occasion 1 (reference 238). As the UE automatically treats each occurrence of Occasion 1 as an initial transmission of new data, when the UE fails to recover the new data from the initial transmission 238, the UE sends a corresponding NACK 250 to the base station and stores the payload of the transmission 238 (e.g., Payload B) in the buffer B1 corresponding to Occasion 1 (reference 242). Thus, the UE overwrites the combination of Payload A(1) and Payload A(2) stored in the buffer B1 (reference 232) with the Payload B (reference 242). Accordingly, the combination of Payload A(1) and Payload A(2) is no longer available to the UE for use in decoding any subsequent retransmissions of Payload A, such as retransmissions sent in response to the NACK 235, as previously discussed with respect to FIG. 2.

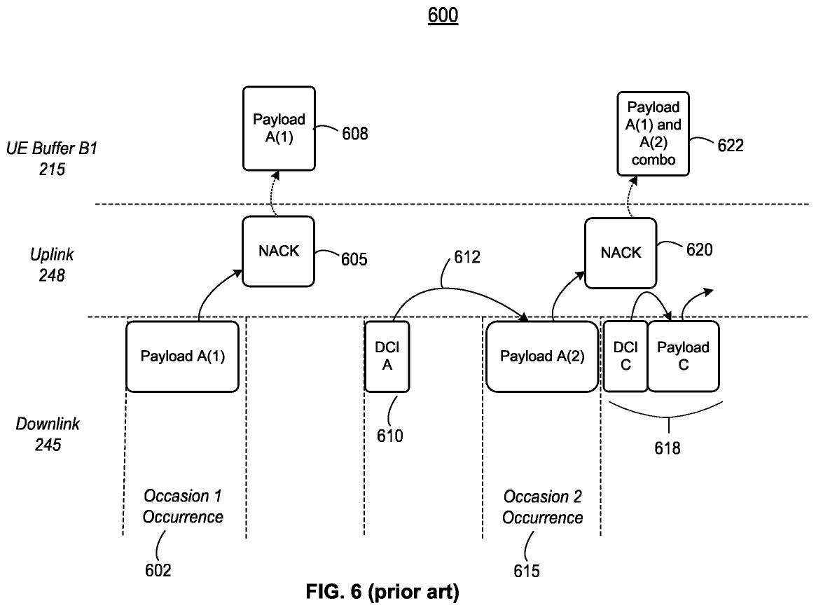

FIG. 6 depicts a proposed prior art solution 600 for preventing the UE from overwriting the buffer contents associated with Occasion 1 before the corresponding data has been successfully decoded or recovered. Similar to FIGS. 2 and 5, the proposed prior art solution 600 utilizes the buffer B1 associated with Occasion 1 (reference 215), the downlink 245, and the uplink 248. As shown in FIG. 6, and similar to FIGS. 2 and 5, the base station sends an initial transmission of data to the UE via an occurrence 602 of periodically scheduled occasion (e.g., Occasion 1), the UE fails to successfully recover the data from the initial transmission 602, and consequently sends a NACK 605 to the base station and stores the payload of the initial transmission 602 (e.g., Payload A(1)) in the buffer B1 (references 215, 608). The base station responds by indicating to the UE, via a DCI 610 transmitted via a PDCCH resource, that the base station will be sending a retransmission of the unrecovered data associated with Occasion 1. In the proposed solution 600, though, instead of sending the retransmission via an assigned PDSCH, the base station delays sending the retransmission of the unrecovered data associated with Occasion 1 (as denoted by reference 612) until the next periodically scheduled occurrence of an occasion (reference 615). In the scenario depicted in FIG. 6, the next periodically scheduled occurrence 615 corresponds to Occasion 2, whose periodically scheduled occurrences are defined to immediately follow the periodically scheduled occurrences of Occasion 1, per the SPS. Accordingly, instead of the base station scheduling new data (e.g., Payload C) to be delivered to the UE during the periodically scheduled occurrence 615 of Occasion 2, the base station schedules the new data to be delivered to the UE during an assigned PDSCH, signals the UE of the impending delivery via a corresponding DCI, and subsequently transmits the new data to the UE via the assigned PDSCH (as denoted by reference 618). As such, in the scenario 600, via the DCI 610, the base station instructs the UE to process the payload of the next periodically scheduled occurrence 615 of an occasion (e.g., Occasion 2) as a retransmission of data included in the initial transmission 602 corresponding to Occasion 1, e.g., Payload A(2). If the UE fails to recover the data from a combination of Payload A(2) of the retransmission 615 and Payload A(1) stored in the buffer B1 (reference 608), the UE sends a corresponding NACK 620 to the base station and stores the combination of Payload A(1) and Payload A(2) (reference 622) in the buffer B 1. Consequently, the UE maintains the information corresponding to payload A in buffer B1 for use in future data recovery attempts.

However, as previously discussed, the proposed prior art solution 600 suffers from several drawbacks. For example, to maintain the PDCCH detection probability under adverse channel conditions such as deep fading, the base station would need to arrange more control channel elements (e.g., CCEs, time/frequency radio resources, etc.) for the PDCCH. As such, the number of available PDCCH resources may be insufficient to schedule a retransmission PDSCH that overwrites the subsequent or next periodically scheduled SPS PDSCH (e.g., PDSCH 615). Additionally, if the base station receives the NACK 605 from the UE in a timeslot immediately prior to the next periodically scheduled occurrence 615, the base station may not have enough time to prepare the retransmission of Payload A to occur during the next periodically scheduled occurrence 615. Further, the base station postpones the new transmission of the new transport block (e.g., Payload C, reference 618) until after the retransmission of the unsuccessfully-decoded transport block (e.g., Payload A, reference 615). Considering the decay of data values over time in latency-sensitive services, a new transmission has a higher data value drop than a retransmission and as such, postponing the new transmission in favor of the retransmission is costlier than allowing the new transmission to proceed as scheduled. Still further, the base station does not utilize the occurrence of Occasion 2 (reference 615) to deliver new data or to retransmit previously sent data corresponding to Occasion 2, thus decreasing overall throughput of data delivery.

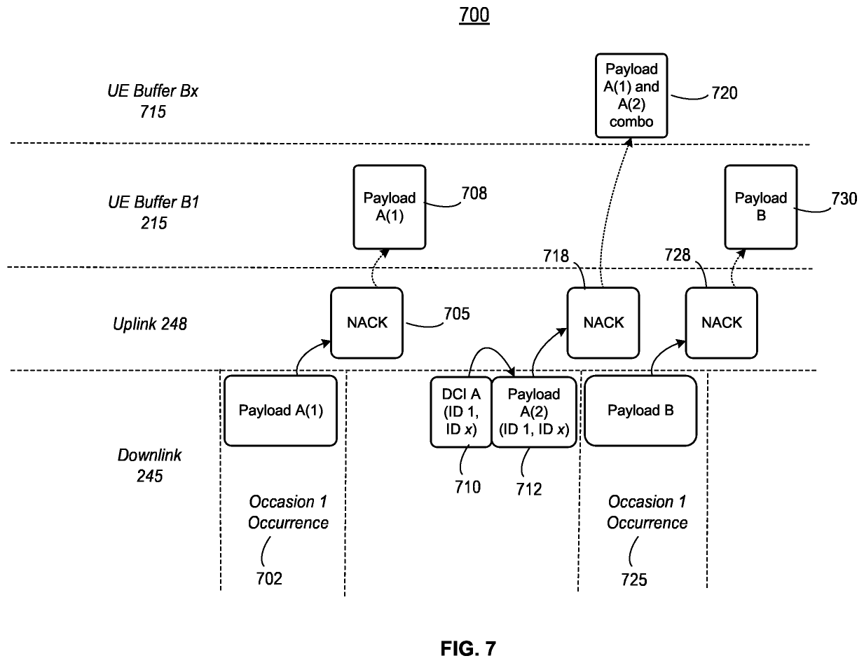

In contrast, the techniques depicted by example scenario 700 shown in FIG. 7 allow unsuccessfully recovered payload information to be maintained and persisted at the UE for use in combination with retransmission payloads for use in attempts to recover data, while allowing new data to be delivered without needless postponement. As shown in FIG. 7, and similar to the scenarios 500 and 600 of FIGS. 5 and 6, respectively, the example scenario 700 utilizes the buffer B1 associated with Occasion 1 (reference 215) at the UE, the downlink 245, and the uplink 248. Also similar to FIGS. 5 and 6, the base station sends an initial transmission of data to the UE via a periodically scheduled occurrence 702 of Occasion 1, the UE fails to successfully recover the data from the initial transmission 702, and consequently sends a NACK 705 to the base station and stores the payload of the initial transmission 702 (e.g., Payload A(1)) in the buffer B1 (references 215, 708) corresponding to Occasion 1.

In response to the NACK 705, the base station informs the UE of an impending non-periodic transmission of Payload A, e.g., via DCI 710 on a PDDCH resource, and retransmits Payload A to the UE during an assigned PDSCH (reference 712). As shown in FIG. 7, the DCI 710 and optionally the retransmission 712 include an indication of the occasion associated with the initial transmission 702, e.g., Occasion 1 denoted by “ID 1.” Additionally, at least one of the DCI 710 or the retransmission 712 may include an indication of another Occasion x, denoted by “ID x,” which indicates the particular occasion to which the UE is to redirect or reallocate the recovery of Payload A. That is, the base station indicates, to the UE via the association of ID 1 and ID x, that the UE is to utilize Occasion x to recover Payload A instead of Occasion 1. Although FIG. 7 illustrates both the DCI 710 and the retransmission 712 as indicating the identifier of the reallocation occasion, e.g., ID x, in some embodiments, only one of the DCI 710 or the retransmission 712 may indicate ID x.

As previously discussed, the base station has configured the UE with a set of occasions corresponding to the connection between the base station and the UE (e.g., in configuration 125), and the UE has allocated a respective buffer at the UE for each configured occasion (e.g., B1-Bn of FIG. 1). By the base station indicating the Occasion x (e.g., via its identifier ID x) in conjunction with the original Occasion 1 (e.g., via its identifier ID 1), the base station notifies the UE to redirect the recovery of the Payload A from being associated with Occasion 1 to being associated with the reallocation Occasion x and, as such, the UE utilizes the buffer allocated to Occasion x (e.g., Buffer Bx (reference 715)) instead of the buffer allocated to Occasion 1 (e.g., Buffer B1 (reference 215)) to store or persist any unrecovered retransmissions of Payload A for use in future recovery attempts. That is, the UE reallocates the storage of unrecovered Payload A from the buffer B1 to the buffer Bx, and the UE persists Payload A (and/or combinations of retransmissions of Payload A) in buffer Bx. As such, this document refers to Occasion x as a “reallocation occasion” with respect to Occasion 1, and buffer Bx as its corresponding “reallocation buffer.” Buffer Bx may or may not be included in the set of buffers B1-Bn, as this document discusses in more detail in other sections.

As shown in FIG. 7, upon the receipt of the retransmission 712, the UE combines (e.g., soft-combines) the payload of the retransmission (e.g., Payload A(2)) with the contents of the buffer B1 (e.g., Payload A(1)), and attempts to recover the data from the combination. In FIG. 7, the recovery attempt is unsuccessful, and accordingly, the UE transmits a NACK 718 to the base station, and, per the base station's redirection, stores the combination of Payload A(1) and Payload A(2) into the reallocation buffer Bx (as denoted by reference 720), and not into the buffer B1. As such, the UE reallocates the storage of the combination of Payload A(1) and Payload A(2) from the buffer B1 to the buffer Bx to thereby maintain or persist the combination for utilization in future recovery attempts based on future retransmissions of Payload A.

Advantageously, due to the redirection and reallocation from Occasion 1 to Occasion x, the UE may utilize the buffer B1 (reference 215) for recovering new data which the base station transmits via further periodic occurrences of Occasion 1. For example, as shown in FIG. 7, the base station schedules new data (e.g., Payload B) for transmission to the UE during the next, periodically scheduled occurrence of Occasion 1 (reference 725), e.g., during the occurrence of Occasion 1 scheduled to periodically occur immediately following the occurrence 702. In this scenario 700, the UE fails to successfully recover Payload B from its initial transmission 725, returns a NACK 728 to the base station, and stores Payload B in buffer B1 allocated for Occasion 1 (as denoted by reference 730). As such, the UE maintains or persists both unrecovered Payload A (in its combined form) and unrecovered Payload B, e.g., in buffers Bx and B1, respectively, and thus the UE may use the persisted information to aid in future recovery attempts, e.g., when the base station sends retransmissions indicating Occasion x for retransmissions of Payload A, and the base station sends retransmissions indicating Occasion 1 for retransmissions of Payload B. In this manner, neither the delivery of Payload A nor the delivery of Payload B is unnecessarily delayed. Moreover, the delivery of data via other occasions which are scheduled to periodically occur between the periodic occurrences of Occasion 1 (e.g., Occasion 2, Occasion 3, . . . , etc., not shown in FIG. 7) are also not unnecessarily delayed or omitted, as the UE may utilize the buffers corresponding to these occasions (e.g., B2, B3, . . . ) for use in data recovery of their corresponding occasions without jeopardizing the loss of Payload A or of Payload B.

The base station or the UE may determine the particular occasion to which the recovery of Payload A is to be redirected or reallocated, e.g., Occasion x. The particular occasion may be predefined, predesignated, or pre-determined, may be dynamically determined, or may be arbitrarily or randomly determined. In an example implementation, the reallocation occasion corresponding to Occasion 1 (e.g., Occasion x) may be an occasion of the configuration 125 whose periodic occurrences are scheduled (per the SPS) to occur at a later or latest time with respect to the periodic occurrences of Occasion 1 than the times of the periodic occurrences of other occasions. For example, if the configuration 125 defines 16 occasions, the base station may determine Occasion x to be the occasion whose occurrences are scheduled to periodically occur immediately prior to those of Occasion 1, e.g., Occasion 16, or some relatively later occurring occurrence within the scheduled occasions, e.g., Occasion 14 or 15. In another example, the base station may arbitrarily or randomly determine Occasion x, and/or may determine Occasion x based on one or more criteria, such as loading, length of queues of data to be delivered, priority of data, etc. In yet another example, the base station may determine Occasion x to be an occasion excluded from the configuration 125. For instance, if the configuration 125 defines Occasions 1-8 are to be used for data recovery, the base station may determine Occasion 9, 10, or 11 to be Occasion x.

In some embodiments, instead of the base station indicating the reallocation occasion to the UE in an in-line manner as denoted by reference 710, 712, Occasion x may be pre-determined and the base station may indicate the pre-determined reallocation occasion to the UE in the configuration 125. For example, the configuration 125 may indicate that the base station has predesignated Occasion x as the reallocation occasion for Occasion 1 and optionally for one or more other occasions, should such situations arise. Accordingly, in these embodiments, instead of the base station specifically indicating ID x in the DCI 710 and/or the retransmission 712, the base station need only generally indicate that the UE is to utilize the predesignated reallocation occasion for Occasion 1 as defined in the configuration 125, e.g., via a flag or some other suitable indication. The configuration 125 may predefine or predesignate different occasions to serve as reallocation occasions (e.g., for respective one or more other occasions), in certain arrangements.

In some embodiments, the UE may determine the reallocation Occasion x (or, alternatively, may determine reallocation buffer Bx) without any input from the base station. In these embodiments, instead of the base station specifically indicating a specific identifier of Occasion x (e.g., ID x) in the DCI 710 and/or the retransmission 712, the base station need only generally signal or indicate to the UE to utilize some suitable reallocation occasion and/or reallocation buffer to service the data recovery attempts of Occasion 1 (e.g., via a flag or some other suitable indication). For example, if the configuration 125 defines 16 occasions, the UE may determine the reallocation Occasion x to be the occasion whose periodically scheduled occurrences are scheduled to occur immediately prior to the periodically scheduled occurrences of Occasion 1, e.g., Occasion 16, or some relatively later occurring occurrence (with respect to occurrences of Occasion 1) within the defined cycle of occasions, e.g., Occasion 14 or 15. In another example, the UE may arbitrarily or randomly determine the reallocation Occasion x, and/or may determine the reallocation Occasion x based on one or more criteria, such as loading, priority of data, etc. In another example, the UE may determine reallocation Occasion x to be an occasion excluded from the configuration 125 and/or an unutilized occasion. For instance, if the configuration 125 defines Occasion 1-8, the UE may determine reallocation Occasion x to be the Occasion 9, 10, or 11. The UE may utilize one or more different approaches for determining different reallocation occasions for different occasions, if desired.

In some embodiments of the message flow 700, the UE 710 clears persisted, unrecovered Payload A (in its combined form) from the reallocation buffer Bx after the UE 710 has received a maximum number of retransmissions of Payload A which the UE 710 has not been able to successfully recover, for example, four, six, etc. As such, after the maximum number of unsuccessfully recovered retransmissions of Payload A have occurred, the UE 710 frees up the reallocation buffer Bx so that the UE 710 may use the reallocation buffer Bx to service another occasion, or for another purpose. The maximum number of unsuccessfully recovered retransmissions may be pre-defined, and may be adjustable. The UE 710 may or may not inform the base station 702 that the UE 710 has cleared or deleted the persisted, unrecovered Payload A.

FIG. 8 depicts a flow diagram of an example method 800 for processing data transmitted from a base station in accordance with semi-persistent scheduling (SPS) and by using a mechanism for automatic retransmission of unsuccessfully delivered data and a reallocation occasion and/or a reallocation buffer, in accordance with at least some of the principles and techniques disclosed within this document. At least a portion of the method 800 may be performed by a UE. In an example implementation, the UE is the UE 110 of FIG. 1, and the UE 110 performs at least a portion of the method 800 by executing the (re)transmission instructions 120 and optionally other instructions 122. In some embodiments, at least a portion of the method 800 may be executed in conjunction with at least portions of one or more other methods described within this document. For example, at least a portion of the method 800 may be executed in conjunction with at least a portion of the method 400 of FIG. 4, and/or in conjunction with at least a portion of the message flow 700 of FIG. 7. In some embodiments, the method 800 includes one or more alternate and/or additional actions other than those shown in FIG. 8. For ease of discussion, and not for limitation purposes, though, this document discusses the method 800 with simultaneous reference to the wireless communication system 100 of FIG. 1 and to the example message flow 700 of FIG. 7, although the method 800 may execute in other wireless communication systems and/or by utilizing other message flows.

The base station configures the UE with a (re)transmission procedure configuration 125 indicating a set of occasions of the mechanism utilized for automatic retransmission of unsuccessfully recovered data sent from the base station to the UE, e.g., in a manner similar to those described elsewhere within this document. Respective occurrences of each occasion may be scheduled to occur periodically, e.g., based on semi-persistent scheduling (SPS). In an embodiment, the set of occasions may be a set of HARQ processes or procedures, where each HARQ procedure is periodically scheduled to deliver data in accordance with the SPS and associated with a respective scheduled PDSCH. Typically, the periodicities of the occurrences of the occasions included in the configured set have relatively short durations, such as less than or equal to ten milliseconds, less than or equal to five milliseconds, or even less than or equal to one millisecond. Each different occasion may be identified via a respective identifier, e.g., a respective occasion identifier.

At a block 802, the method 800 includes receiving, by processing hardware of the UE, a transmission of data from the base station using the mechanism. The transmission of the data is associated with a periodic occurrence of an occasion scheduled according to the SPS and defined in the configuration 125, such as Occasion 1. At a block 805, the method 800 includes determining an identifier of the occasion associated with the received transmission, e.g., the identifier of Occasion 1, or Identifier 1.

In an embodiment, receiving the transmission of data 802 includes receiving an initial transmission of new data from the base station to the UE. As such, in this embodiment, determining the identifier of the occasion 805 may be based on the association of the occasion with the scheduled PDSCH via which the UE received the transmission 802, e.g., as defined in the configuration 125. In this embodiment, the method 800 includes attempting to recover the data from the payload of the received initial transmission (not shown).

In another embodiment, receiving the transmission of data 802 includes receiving a retransmission of data which was previously transmitted from the base station to the UE and unsuccessfully recovered. In a first example scenario, the UE may receive the retransmission 802 during a scheduled PDSCH corresponding to the occasion associated with the data's initial transmission, and as such, determining the identifier of the occasion 805 may be based on the association of the occasion and the scheduled PDSCH via which the UE received the retransmission 802, e.g., as defined in the configuration 125. In a second example scenario, the UE may receive the retransmission 802 in between periodic occurrences of the occasion associated with the data's initial transmission, e.g., in conjunction with a DCI indicating the non-periodic retransmission. Accordingly, determining the identifier of the occasion 805 may include determining the identifier of the occasion based on an occasion identifier (e.g., Identifier 1) or other suitable indication of the occasion included in the retransmission 802 and/or included in the corresponding DCI. At any rate, in this embodiment, the method 800 includes combining the payload of the received retransmission 802 with the current content of a buffer (e.g., a soft buffer) corresponding to the identified occasion (e.g., buffer B1 corresponding to Occasion 1). The contents of the buffer typically include the payload of one or more previous (re)transmissions of the data, which may be in a combined (e.g., a soft-combined) form, for example. Additionally, in this embodiment, the method 800 includes attempting to recover the data from the combination of the payload of the retransmission 802 and the current buffer contents (not shown). For example, the method 800 may include soft-combining the payload of the retransmission 802 with the current contents of the buffer B1, and attempting to recover the data of the initial transmission from the soft-combination.

At a block 808, the method 800 includes failing to recover the data included in the received transmission 802, whether by processing the received payload singularly (such as when the received transmission 802 is an initial transmission of new data) or by processing the received payload in combination with previously received payload(s) (such as when the received transmission is a retransmission of previously transmitted and unrecovered data). The failure may be due to, for example, a discovery of corruption in the data or payload, a failure to decode the data or payload, a failure to decode a combination of the payload of the transmission and data previously stored in the buffer, and/or a failure to receive a medium access control layer protocol data unit (MAC PDU) corresponding to the transmission. Of course, other conditions may additionally or alternatively cause the failure.

Upon failing to successfully recover the data included in the received transmission (block 808), the method 800 includes sending a corresponding negative acknowledgement (NACK) to the base station (block 810) and, at a block 812, storing and persisting, based on an association between the identifier of the occasion and an identifier of another, second occasion (e.g., Occasion x), the payload of the received transmission 802 in another buffer which corresponds to the second occasion (e.g., buffer Bx). For example, if the received transmission 802 is an initial transmission of new data, the UE may store and persist the payload of the initial transmission in the reallocation buffer Bx. In another example, if the received transmission 802 is a retransmission, the UE may store and persist, in the reallocation buffer Bx corresponding to the second occasion, a combination (e.g., a soft-combination) of a current content of the buffer B1 corresponding to the first occasion and the payload of the received transmission 802. Accordingly, the UE reallocates the occasion associated with the automatic retransmission of unsuccessfully recovered data of the initial transmission from Occasion 1 to Occasion x, and the UE reallocates the buffer used to store and persist contents of payloads of the initial transmission and of any retransmissions (e.g., in a combined or soft-combined format) for use in future recovery attempts from buffer B1 to buffer Bx.

In an embodiment, persisting the payload of the received transmission 802 in the reallocation or second buffer Bx (block 812) includes persisting the payload of the transmission in the reallocation or second buffer Bx over a length of time greater than a length of a periodicity of the first occasion (e.g., of Occasion 1), where the periodicity of the first occasion is defined in accordance with the SPS. Indeed, the UE may persist the payload of the received transmission in the reallocation buffer Bx while processing data received from the base station during other periodically scheduled occurrences of occasions, such as periodically scheduled occurrences of Occasion 1 and other occasions.

For example, based on the SPS, each occurrence of Occasion 2 may be scheduled to periodically reoccur immediately after a periodically scheduled occurrence of Occasion 1. In this example, the method 800 may include receiving an initial transmission of new, second data during the periodic occurrence of Occasion 2 scheduled to immediately follow the periodic occurrence of Occasion 1 associated with the received transmission 802. As such, the method 800 may include failing to recover the new, second data from its initial transmission and maintaining a payload of the initial transmission of the new, second data in a buffer B2 associated with Occasion 2, while maintaining or persisting the payload of the received transmission 802 (perhaps in combined form) in the reallocation buffer Bx. As such, both the delivery of the data associated with the received transmission 802 and the delivery of the new, second data are not unnecessarily delayed, as the UE maintains and persists the information corresponding to their unsuccessfully recovered payload, e.g., in buffers Bx and B2, respectively, and thus the UE may utilize the persisted information in future data recovery attempts.

In another example, the method 800 may include receiving an initial transmission of new, second data during a subsequent, periodically scheduled occurrence of Occasion 1, that is, during the periodic occurrence of Occasion 1 scheduled to occur immediately following the occurrence of Occasion 1 associated with the received transmission 802. In this example, the method 800 may include failing to recover the new, second data from its initial transmission, and maintaining a payload of the initial transmission of the new, second data in the buffer B1 associated with Occasion 1, while maintaining or persisting the payload of the received transmission 802 in the reallocation buffer Bx. Accordingly, both the delivery of the data associated with the received transmission 802 and the delivery of the new, second data transmitted via Occasion 1 are not unnecessarily delayed, as the UE maintains and persists the information corresponding to their unsuccessfully recovered payload, e.g., in buffers Bx and B1, respectively, and accordingly the UE may utilize the persisted information in future data recovery attempts.

In an embodiment (not shown in FIG. 8), the method 800 may further include determining, by the processing hardware of the UE, the association between the first occasion identifier and the second association identifier. For example, the UE may receive an indication of the association between the first and second association identifiers from the base station, e.g., in conjunction with the received transmission 802, such as in the received transmission 802 itself, and/or in a DCI corresponding to the received transmission 802. For example, the base station may send both the identifier of the first occasion (e.g., Identifier 1) and the identifier of the second, reallocation occasion (e.g., Identifier x) as the indication of the association between the first and second association identifiers. The base station may have determined the second occasion as the reallocation occasion for the first occasion based on, for example, an ordering of occasions as defined by the configuration, based on one or more dynamic conditions (e.g., loading, data priority, lengths of queues, etc.), by arbitrarily or randomly selecting the second occasion identifier, or based on whether or not the mechanism utilizes the second occasion for automatic retransmissions with respect to the UE. For example, the base station may determine the reallocation occasion to be an occasion which has not been configured for use by the base station and UE. In another example, the base station may determine the reallocation occasion to be an available, configured occasion, or the occasion whose periodically scheduled occurrences immediately precede periodically scheduled occurrences of the first occasion.

In another example, rather than the base station explicitly identifying the reallocation occasion to the UE, the base station may send a flag or other indicator to the UE in conjunction with the identifier of the first occasion (e.g., Identifier 1) to indicate to the UE to utilize a pre-configured reallocation occasion for the first occasion, or to otherwise select or determine a suitable reallocation occasion without input from the base station. In this example, the UE may determine the association between the first occasion identifier and the second occasion identifier by, for example, obtaining the identifier of a pre-designated reallocation occasion corresponding to the first occasion from the (re)transmission configuration 125, selecting the second occasion identifier based on an ordering of occasions as defined by the configuration and/or based on one or more dynamic conditions, by arbitrarily or randomly selecting the second occasion identifier, or by some other determination criteria.

At any rate, upon determining the association between the first occasion identifier and the second occasion identifier, the method 800 may include storing an indication of the association between the first occasion identifier and the second occasion identifier, in embodiments.

In some embodiments (not shown), the method 800 further includes recovering the data associated with the received transmission 802 from a content of the second, reallocation buffer, and transmitting a positive acknowledgement to the base station. For example, the UE may receive, from the base station using the mechanism, a retransmission of the data associated with the received transmission 802, wherein the retransmission is associated with the second occasion identifier. For instance, the retransmission may be received during a scheduled PDSCH associated with a periodically scheduled occurrence of the second occasion, or the retransmission may be received during an assigned PDSCH in conjunction with a corresponding DCI which includes an indication of or otherwise identifies the second occasion. Based on the identified second, reallocation occasion, the UE may combine (e.g., soft-combine) the payload of the retransmission with a current content of the second, reallocation buffer Bx, and attempt to recover the original data from the combination. If the recovery attempt is successful, the UE may transmit the corresponding ACK to the base station. If the recovery attempt is again unsuccessful, the UE may transmit a corresponding NACK to the base station, and store and persist the combination of the payload of the retransmission and the content of the second buffer Bx as updated content of the second buffer Bx to await a further retransmission.

In some embodiments (not shown), the method 800 further includes clearing the second, reallocation buffer after a maximum number of unsuccessful recoveries of retransmissions of the payload corresponding to the received transmission 802 have occurred, e.g., four, six, etc., and optionally informing the base station that the UE has cleared or deleted the persisted, unrecovered payload corresponding to the received transmission 802. As such, the second, reallocation buffer is freed up, e.g., to serve as a reallocation buffer for another occasion, or for other purposes. The maximum number of unsuccessfully recovered retransmissions may be pre-defined, and may be adjustable.

With particular regard to DCIs which inform the UE of an impending, non-periodic retransmission of unrecovered data (e.g., DCI 330, DCI 710, or the DCI indicating the transmission 802), DCIs corresponding to retransmissions for which the usage of a known, or presently utilized recovery occasion is to be continued (e.g., DCI 330) may differ from DCIs which signal or indicate to the UE that recovery occasion is to be redirected or reallocated to another occasion (e.g., DCI 710, or the DCI indicating the transmission 802). As both types of DCIs indicate retransmissions of previously sent data, the New Data Indicator (NDI) field of both types of DCIs may indicate “retransmission,” e.g., NDI=1. However, the formats of the two types of DCIs may differ. For example, one type of DCI may include a Cyclic Redundancy Check (CRC) scrambled with a first Radio Network Temporary Identifier (RNTI), while the other type of DCI may include a CRC scrambled with a second RNTI different than the first RNTI. For example, the first RNTI may be a Cell RNTI (C-RNTI) and the second RNTI may be a Configured Scheduling RNTI (CS-RNTI), or vice versa. Additionally or alternatively, a value of a format flag field may differ between the two types of DCIs. Other suitable format differences may be utilized to distinguish between the two different types of DCIs. As such, based on these format differences, the UE can discern whether or not to determine a reallocation occasion for the known occasion which the UE presently utilizes for data recovery purposes.

The following additional considerations apply to the foregoing discussion.

A user device or User Equipment (UE) in which the techniques of this document can be implemented (e.g., the UE 110, 310) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this document as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this document, those of skill in the art will appreciate still additional alternative structural and functional designs for enhancing the handling of user equipment in a radio resource control inactive state through the principles disclosed in this document. Thus, while this document illustrates and describes particular embodiments and applications, the disclosed embodiments are not limited to the precise construction and components disclosed. Various modifications, changes and variations, which will be apparent to those of ordinary skill in the art, may be made in the disclosed arrangement, operation and details of the method, and apparatus without departing from the spirit and scope defined in the appended claims.

The following list of examples reflects a variety of embodiments explicitly contemplated by the present disclosure.

Example 1. A method in a user equipment (UE) for processing data transmitted from a base station in accordance with semi-persistent scheduling (SPS) and by using a mechanism for automatic retransmission of unsuccessfully delivered data, the method comprising:
receiving, by processing hardware of the UE, a transmission of data from the base station using the mechanism, the transmission of the data associated with an occasion scheduled according to the SPS; and, in response to a failure to recover the data included in the transmission:
persisting, by the processing hardware in a buffer corresponding to the occasion, a payload of the transmission; sending, by the processing hardware, a negative acknowledgment to the base station; and activating a retransmission timer during which the UE processes one or more retransmissions of the data associated with the occasion from the base station using the mechanism.

Example 2. The method of example 1, further comprising deactivating, by the processing hardware of the UE, the retransmission timer upon successfully recovering a content of the buffer.

Example 3. The method of example 1, further comprising clearing, by the processing hardware of the UE, a content of the buffer in response to an expiration of the retransmission timer.

Example 4. The method of any one of the preceding examples, wherein: the transmission is a retransmission of data included in an initial transmission from the base station to the UE using the mechanism; and persisting the payload of the retransmission in the buffer corresponding to the occasion includes persisting, in the buffer corresponding to the occasion, a combination of the payload of the retransmission with a payload of the initial transmission.

Example 5. The method of the preceding example, wherein persisting the combination of the payload of the retransmission with the payload of the initial transmission in the buffer corresponding to the occasion comprises: persisting the combination of the payload of the retransmission with the payload of the initial transmission in the buffer corresponding to the occasion over a length of time greater than a length of a periodicity of the occasion, the periodicity defined in accordance with the SPS.

Example 6. The method of any one of examples 4-5, wherein the retransmission is a first retransmission, the combination is a first combination, and the method further comprises, while the retransmission timer is activated:
receiving a second retransmission of the data from the base station using the mechanism; generating, by the processing hardware of the UE, a second combination of a payload of the second retransmission and the persisted first combination; and persisting the second combination in the buffer corresponding to the occasion.

Example 7. The method of the preceding example, further comprising persisting the second combination in the buffer over a length of time greater than a length of a periodicity of the occasion defined in accordance with the SPS.

Example 8. The method of any one of the preceding examples, wherein the failure to recover the data included in the transmission includes at least one of: a discovery of corruption in the data; a failure to decode the data; a failure to decode a combination of a payload of the transmission and data previously stored in the buffer; or a failure of the processing hardware of the UE to receive a medium access control layer protocol data unit (MAC PDU) corresponding to the transmission.

Example 9. The method of any one of the preceding examples, further comprising tuning a duration of the retransmission timer in accordance with at least one of: a configuration of SPS procedures at the UE, a traffic load, a processing load, or a channel condition.

Example 10. The method of any one of the preceding examples, further comprising, subsequent to activating the retransmission timer: recovering the data from a content of the buffer corresponding to the occasion; deactivating the retransmission timer based on the recovering of the data; and transmitting, by the processing hardware of the UE, a positive acknowledgement to the base station.

Example 11. The method of the preceding example, wherein the occasion is a first occurrence of the occasion, the data is first data, and the method further comprises, after transmitting the positive acknowledgement to the base station:
receiving, by the processing hardware of the UE from the base station using the mechanism and during a second occurrence of the occasion associated with the buffer, an initial transmission of second data; and overwriting any content of the buffer corresponding to the occasion with a payload of the initial transmission of the second data.

Example 12. The method of the preceding example, further comprising reactivating the retransmission timer upon at least one of: a failure to recover the second data included in the initial transmission of the second data, or a failure to receive a medium access control layer protocol data unit (MAC PDU) corresponding to the initial transmission of the second data.

Example 13. The method of any one of examples 1-3 and 8-12, wherein the transmission of the data is an initial transmission of the data from the base station to the UE using the mechanism.

Example 14. The method of any one of the preceding examples, further comprising, while the retransmission timer is activated: receiving a retransmission of the data from the base station using the mechanism; combining a payload of the retransmission with a current content of the buffer corresponding to the occasion; and attempting to recover the data associated with the occasion from the combination.

Example 15. The method of the preceding example, wherein: the occasion associated with the buffer is a first periodically scheduled occasion corresponding to the SPS; receiving the retransmission of the data includes receiving the retransmission and an occasion identifier indicative of the first periodically scheduled occasion during an occurrence of a second periodically scheduled occasion corresponding to the SPS, each occurrence of the second periodically scheduled occasion scheduled to immediately follow a respective occurrence of the first periodically scheduled occasion; and combining the payload of the retransmission with the current content of the buffer is based on the received occasion identifier.

Example 16. The method of example 14, wherein: the occasion associated with the buffer is a first periodically scheduled occasion corresponding to the SPS; and receiving the retransmission of the data includes receiving the retransmission of the data prior to an occurrence of a second periodically scheduled occasion corresponding to the SPS, each occurrence of the second periodically scheduled occasion scheduled to immediately follow a respective occurrence of the first periodically scheduled occasion.

Example 17. The method of any one of the preceding examples, wherein the occasion is periodically scheduled in accordance with the SPS, and a length of a periodicity of the occasion is less than ten milliseconds.

Example 18. The method of the preceding example, wherein the length of the periodicity of the occasion is less than one millisecond.

Example 19. The method of any one of the preceding examples, wherein receiving the transmission of the data associated with the occasion includes receiving the transmission of data during a periodically-scheduled occurrence of the occasion.

Example 20. The method of any one of examples 1-18, wherein receiving the transmission of the data associated with the occasion includes receiving the transmission of data in between periodically-scheduled occurrences of the occasion in accordance with downlink control information (DCI).

Example 21. The method of any one of the preceding examples, wherein a duration of the retransmission timer is greater than a length of a periodicity of the occasion.

Example 22. A User Equipment (UE) configured to perform the method of any one of examples 1-21.

Example 23. The UE of example 22, wherein the base station configures the UE to perform at least a portion of the method of any one of examples 1-21.

Example 24. A system configured to perform the method of any one of examples 1-21.

Example 25. A method in a user equipment (UE) for processing data transmitted from a base station in accordance with semi-persistent scheduling (SPS) and by using a mechanism for automatic retransmission of unsuccessfully-delivered data, the method comprising:
receiving, by processing hardware of the UE from the base station using the mechanism, a transmission of data corresponding to an occasion scheduled according to the SPS; determining a first occasion identifier corresponding to the occasion and associated with a first buffer at the UE; and, in response to a failure to recover the data included in the transmission:
sending, by the processing hardware, a negative acknowledgment to the base station; and based on an association between the first occasion identifier and a second occasion identifier, persisting, by the processing hardware, a payload of the transmission in a second buffer associated with the second occasion identifier.

Example 26. The method of the preceding example, further comprising storing the association between the first occasion identifier and the second occasion identifier.

Example 27. The method of any one of the examples 25-26, further comprising determining, by the processing hardware, the association between the first occasion identifier and the second association identifier.

Example 28. The method of the preceding example, wherein determining the association between the first occasion identifier and the second association identifier includes receiving, by the processing hardware from the base station, an indication of the association between the first occasion identifier and the second occasion identifier.

Example 29. The method of the preceding example, wherein receiving the indication of the association between the first occasion identifier and the second occasion identifier comprises receiving the indication of association between the first occasion identifier and the second occasion identifier in conjunction with receiving the transmission of the data corresponding to the occasion.

Example 30. The method of example 27, wherein determining, by the processing hardware, the association between the first occasion identifier and the second occasion identifier includes one of: determining the association between the first occasion identifier and the second occasion identifier based on a configuration stored at the UE; selecting the second occasion identifier based on an ordering of occasions as defined by the configuration and/or based on a dynamic condition; or arbitrarily or randomly selecting the second occasion identifier.

Example 31. The method of any one of examples 25-30, wherein receiving the transmission of the data corresponding to the occasion includes receiving the transmission of data during a periodically-scheduled occurrence of the occasion.

Example 32. The method of any one of examples 25-30, wherein receiving the transmission of the data corresponding to the occasion includes receiving the transmission of data in between periodically-scheduled occurrences of the occasion.

Example 33. The method of any one of examples 25-29 and 31-32, wherein the base station selects the second occasion identifier.

Example 34. The method of any one of examples 25-33, wherein the second occasion identifier is selected randomly.

Example 35. The method of any one of examples 25-34, wherein the data is first data, the occasion is a first occasion, and the method further comprises: receiving, by the processing hardware during a second occasion that is scheduled, according to the SPS, to immediately follow the first occasion, an initial transmission of second data from the base station using the mechanism; and storing a payload of the initial transmission of the second data in a particular buffer associated with a particular occasion identifier corresponding to the second occasion while persisting the payload of the transmission of the first data in the second buffer associated with the second occasion identifier.

Example 36. The method of any one of examples 25-35, wherein the data is first data, the occasion is a periodically-scheduled occasion, the transmission of the first data corresponds to a first occurrence of the periodically-scheduled occasion, and the method further comprises: receiving, by the processing hardware from the base station and during a second occurrence of the periodically-scheduled occasion, an initial transmission of second data using the mechanism; and storing a payload of the initial transmission of the second data in the first buffer associated with the first occasion identifier and the periodically-scheduled occasion while persisting the payload of the transmission of the first data in the second buffer associated with the second occasion identifier.

Example 37. The method of any one of examples 25-36, wherein a configuration of the mechanism at the UE includes a set of occasion identifiers corresponding to a set of occasions of the mechanism, and the set of occasion identifiers excludes the second occasion identifier.

Example 38. The method of any one of examples 25-37, wherein the occasion is a first periodically-scheduled occasion, the second occasion identifier corresponds to a second periodically-scheduled occasion, and each occurrence of the first periodically-scheduled occasion is scheduled in accordance with the SPS to immediately follow a respective occurrence of the second periodically-scheduled occasion.

Example 39. The method of any one of examples 25-38, wherein persisting the payload of the transmission in the second buffer includes persisting the payload of the transmission in the second buffer over a length of time greater than a length of a periodicity of the occasion, the periodicity defined in accordance with the SPS.

Example 40. The method of any one of examples 25-39, further comprising combining a payload of the retransmission with a current content of the first buffer and failing to recover the data from the combination; and wherein persisting the payload of the transmission in the second buffer comprises persisting, in the second buffer, the combination of the payload of the transmission and the current content of the first buffer.

Example 41. The method of the preceding example, wherein the current content of the first buffer includes a combination of more than one received payload corresponding to the data.

Example 42. The method of any one of examples 25-41, wherein the failure to recover the data included in the transmission includes at least one of: a discovery of corruption in the data; a failure to decode the data; a failure to decode a combination of a payload of the transmission and data previously stored in the buffer; or a failure of the processing hardware of the UE to receive a medium access control layer protocol data unit (MAC PDU) corresponding to the transmission.

Example 43. The method of any one of examples 25-42, further comprising: recovering the data from a content of the second buffer; and transmitting, by the processing hardware of the UE, a positive acknowledgement to the base station.

Example 44. The method of the preceding example, recovering the data from the content of the second buffer includes recovering the data from a combination of a content persisted in the second buffer and a payload of another retransmission.

Example 45. The method of any one of examples 25-44, wherein: the transmission is a first retransmission of data included in an initial transmission from the base station to the UE using the mechanism; persisting the payload of the first retransmission in the second buffer includes persisting, in the second buffer, a first combination of a payload of the initial transmission and the payload of the first retransmission; and the method further comprises:
receiving, from the base station using the mechanism, a second retransmission of the data, the second retransmission of the data associated with the second occasion identifier; and
based on the second occasion identifier associated with the second retransmission:
generating, by the processing hardware of the UE, a second combination of a payload of the second retransmission and the persisted first combination; and persisting the second combination in the second buffer.

Example 46. The method of the preceding example, further comprising persisting the second combination in the second buffer over a length of time greater than a length of a periodicity of the occasion defined in accordance with the SPS.

Example 47. The method of any one of examples 45-46, wherein downlink control information (DCI) of the second retransmission is different than downlink control information of the first retransmission.

Example 48. The method of the preceding example, wherein the DCI of the first retransmission includes a Cyclic Redundancy Check (CRC) scrambled with a first Radio Network Temporary Identifier (RNTI), and the DCI of the second retransmission includes a CRC scrambled with a second RNTI different than the first RNTI.

Example 49. The method of the preceding example, wherein one of the first RNTI or the second RNTI is a Cell RNTI (C-RNTI) and the other one of the first RNTI or the second RNTI is a Configured Scheduling RNTI (CS-RNTI).

Example 50. The method of any one of examples 47-49, wherein a value of a format flag field of the DCI of the first retransmission differs from a value of the format flag field of the DCI of the second retransmission.

Example 51. The method of any one of examples 25-50, wherein a set of buffers at the UE includes the first buffer, and each buffer of the set of buffers corresponds to a different occasion identifier of a plurality of occasion identifiers of a plurality of procedures corresponding to the mechanism and configured at the UE.

Example 52. The method of the preceding example, wherein the set of buffers includes the second buffer.

Example 53. The method of any one of examples 25-52, wherein the occasion is periodically scheduled in accordance with the SPS, and a length of a periodicity of the occasion is less than ten milliseconds.

Example 54. The method of the preceding example, wherein the length of the periodicity of the occasion is less than one millisecond.

Example 55. A User Equipment (UE) configured to perform the method of any one of examples 25-54.

Example 56. The UE of example 55, wherein the base station configures the UE to perform at least a portion of the method of any one of examples 25-54.

Example 57. A system configured to perform the method of any one of examples 25-54.

Example 58. Any one of the examples 1-24 in combination with any other one of the examples 1-24.

Example 59. Any one of the examples 25-57 in combination with any other one of examples 25-57.

Example 60. The method of any one of examples 1-21 in combination with the method of any one of examples 25-54.

Example 61. A User Equipment (UE) configured to perform the method of example 60.

Example 62. The UE of example 61, wherein the base station configures the UE to perform at least a portion of the method of example 60.

Example 63. A system configured to perform the method of example 60.

Example 64. Any one of the preceding examples in combination with any other one of the preceding examples.

1. A method in a user equipment (UE) for processing data transmitted from a base station in accordance with semi-persistent scheduling (SPS) and by using a mechanism for automatic retransmission of unsuccessfully delivered data, the method comprising:
receiving, by the UE, a transmission of data from the base station using the mechanism, the transmission of the data associated with an occasion scheduled according to the SPS; and
in response to a failure to recover the data included in the transmission:
sending, by the UE, a negative acknowledgment to the base station;
activating a retransmission timer during which the UE processes one or more retransmissions of the data associated with the occasion from the base station using the mechanism; and
persisting, by the UE in a buffer corresponding to the occasion, a payload of the transmission over a length of time greater than a length of a periodicity of the occasion defined in accordance with the SPS.

2. The method of claim 1, further comprising at least one of:
deactivating, by the UE, the retransmission timer upon successfully recovering a content of the buffer; or
clearing, by the UE, a content of the buffer in response to an expiration of the retransmission timer.

3. The method of claim 1, wherein:
the transmission is a retransmission of data included in an initial transmission from the base station to the UE using the mechanism; and
persisting the payload of the retransmission in the buffer corresponding to the occasion includes persisting, in the buffer corresponding to the occasion, a combination of the payload of the retransmission with a payload of the initial transmission.

4. The method of claim 3, wherein the retransmission is a first retransmission, the combination is a first combination, and the method further comprises, while the retransmission timer is activated:
receiving a second retransmission of the data from the base station using the mechanism;
generating, by the UE, a second combination of a payload of the second retransmission and the persisted first combination; and
persisting the second combination in the buffer corresponding to the occasion.

5. The method of claim 1, further comprising tuning a duration of the retransmission timer in accordance with at least one of: a configuration of SPS procedures at the UE, a traffic load, a processing load, or a channel condition.

6. The method of claim 1, wherein the occasion is a first occurrence of the occasion, the data is first data, and the method further comprises:
transmitting, by the UE subsequent to reactivating retransmission timer, a positive acknowledgement to the base station; and
after transmitting the positive acknowledgement to the base station:
receiving, by the UE from the base station using the mechanism and during a second occurrence of the occasion associated with the buffer, an initial transmission of second data;
overwriting any content of the buffer corresponding to the occasion with a payload of the initial transmission of the second data; and
reactivating the retransmission timer upon at least one of: a failure to recover the second data included in the initial transmission of the second data, or a failure to receive a medium access control layer protocol data unit (MAC PDU) corresponding to the initial transmission of the second data.

7. The method of claim 1, wherein the transmission of the data is an initial transmission of the data from the base station to the UE using the mechanism.

8. The method of claim 1, wherein receiving the transmission of the data associated with the occasion includes receiving the transmission of data in between periodically-scheduled occurrences of the occasion in accordance with downlink control information (DCI).

9. The method of claim 1, wherein a duration of the retransmission timer is greater than the length of the periodicity of the occasion.

10. A method in a user equipment (UE) for processing data transmitted from a base station in accordance with semi-persistent scheduling (SPS) and by using a mechanism for automatic retransmission of unsuccessfully-delivered data, the method comprising:
receiving, by the UE from the base station using the mechanism, a transmission of data corresponding to an occasion scheduled according to the SPS;
determining a first occasion identifier corresponding to the occasion and associated with a first buffer at the UE; and
in response to a failure to recover the data included in the transmission:
sending, by the UE, a negative acknowledgment to the base station; and
based on an association between the first occasion identifier and a second occasion identifier, persisting, by the UE, a payload of the transmission in a second buffer associated with the second occasion identifier over a length of time greater than a length of a periodicity of the occasion, the periodicity defined in accordance with the SPS.

11. The method of claim 10, further comprising storing the association between the first occasion identifier and the second occasion identifier.

12. The method of claim 10, further comprising receiving, by the UE from the base station, an indication of the association between the first occasion identifier and the second occasion identifier.

13. The method of claim 10, further comprising:
determining, by the UE, the association between the first occasion identifier and the second occasion identifier based on a configuration stored at the UE;
selecting, by the UE, the second occasion identifier based on an ordering of occasions as defined by the configuration and/or based on a dynamic condition; or
arbitrarily or randomly selecting, by the UE, the second occasion identifier.

14. The method of claim 10, wherein the data is first data, the occasion is a first occasion, and the method further comprises:
receiving, by the UE during a second occasion that is scheduled, according to the SPS, to immediately follow the first occasion, an initial transmission of second data from the base station using the mechanism; and
storing a payload of the initial transmission of the second data in a particular buffer associated with a particular occasion identifier corresponding to the second occasion while persisting the payload of the transmission of the first data in the second buffer associated with the second occasion identifier.

15. The method of claim 10, wherein the data is first data, the occasion is a periodically-scheduled occasion, the transmission of the first data corresponds to a first occurrence of the periodically-scheduled occasion, and the method further comprises:
receiving, by the UE from the base station and during a second occurrence of the periodically-scheduled occasion, an initial transmission of second data using the mechanism; and
storing a payload of the initial transmission of the second data in the first buffer associated with the first occasion identifier and the periodically-scheduled occasion while persisting the payload of the transmission of the first data in the second buffer associated with the second occasion identifier.

16. The method of claim 10, wherein a configuration of the mechanism at the UE includes a set of occasion identifiers corresponding to a set of occasions of the mechanism, and the set of occasion identifiers excludes the second occasion identifier.

17. The method of claim 10, wherein:
the transmission is a first retransmission of data included in an initial transmission from the base station to the UE using the mechanism and the length of time is a first length of time;
persisting the payload of the first retransmission in the second buffer includes persisting, in the second buffer, a first combination of a payload of the initial transmission and the payload of the first retransmission; and
the method further comprises:
receiving, from the base station using the mechanism, a second retransmission of the data, the second retransmission of the data associated with the second occasion identifier; and
based on the second occasion identifier associated with the second retransmission:
generating, by the UE, a second combination of a payload of the second retransmission and the persisted first combination; and
persisting the second combination in the second buffer over a second length of time greater than the length of the periodicity of the occasion defined in accordance with the SPS.

18. The method of claim 17, wherein downlink control information (DCI) of the second retransmission is different than downlink control information of the first retransmission.

19. The method of claim 10, wherein a set of buffers at the UE includes the first buffer and the second buffer, and each buffer of the set of buffers corresponds to a different occasion identifier of a plurality of occasion identifiers of a plurality of procedures corresponding to the mechanism and configured at the UE.

20. The method of claim 10, wherein the occasion is periodically scheduled in accordance with the SPS, and the length of the periodicity of the occasion is less than ten milliseconds.

21. (canceled)
